(19) United States
(12) Patent Application Publication
(10) Pub. No.: US 2026/0242015 A1
(43) Pub. Date: Aug. 20, 2026

(54) DEPLOYABLE SURVEILLANCE, SECURITY AND/OR ENFORCEMENT SYSTEM

(71) Applicant: Exsis Limited, Luton, Bedfordshire (GB)

(72) Inventor: Clebert O'Bryan Ricardo YEARWOOD, Luton, Bedfordshire (GB)

(21) Appl. No.: 19/159,710

(22) PCT Filed: Feb. 27, 2024
(86) PCT No.: PCT/EP2024/054919

§ 371 Date: Aug. 26, 2025

(30) Foreign Application Priority Data
Feb. 27, 2023 (GB) 2302809.5

(51) Int. Cl. B62D 55/10; A62C 3/07; B60H 1/00; B60K 1/04; B60S 9/06; H01Q 1/08

(52) U.S. Cl. CPC B62D 55/10; B60K 1/04; B60S 9/06; H01Q 1/08; A62C 3/07; B60H 1/00007

(57) ABSTRACT

There is described a deployable surveillance, security and/or enforcement system, comprising: a deployable surveillance, security and/or enforcement unit configured for deployment at a surveillance, security and/or enforcement location, the unit comprising two or more removable modules having equipment for performing surveillance, security and/or enforcement operations and the unit having a housing with at least one opening for receiving the two or more modules into the unit; and one or more bogies, each bogie 2024/180042 comprising a chassis, wheelset and a pair of continuous tracks, each of the continuous tracks formed of linked track plates and the continuous tracks driven by one or more wheels of the wheelset, the bogie detachably coupled to the deployable surveillance, security and/or enforcement unit. Units are further described comprising one or more of: lifting jacks; an air-conditioning system configured to filter received external air; a retractable satellite antenna; a door system; and a fire suppression system.

WO

### FIELD OF THE INVENTION

The present invention relates to a surveillance, security and enforcement management unit and method. For example, aspects of the invention relate to a security management vehicle having an integrated six-axis robotic arm and cabin.

### BACKGROUND

Conventional methods and apparatus for surveillance comprise CCTV cameras often mounted on buildings or vehicles. The cameras are either fixed or can be controlled to move to alter the direction of their scene of view. A security or police command centre receives data from one or more cameras to allow command personnel to assess video received from the one or more cameras. Based on the video personnel are able to make decisions concerning safety, security and enforcement.

At large events or venues a significant number of cameras may be present at fixed positions around the location. Events such as football matches occur at predetermined venues such as football grounds and the surveillance requirements at the venue are largely unvarying from match to match. The surveillance requirements are often determined by the size of the venue and number of people attending the venue. A similar situation arises with concerts whereby the number of people attending is determined by the size of the concert venue.

Other large events are less predictable, such as concerts in outdoors location, large sporting events occurring at multiple closely located venues simultaneously (for example, the Commonwealth Games or Olympics). Another example is a football match in which a team have a large number of supporters visiting a lesser supported team. In these situations the surveillance infrastructure is not set up to meet the demands of the large increase in people at the location or venue. While investment in permanent surveillance infrastructure would alleviate this problem it is costly and the infrastructure may only be need for one event or a very limited number of events. Hence, the infrastructure cost cannot be justified for such a limited time period. There is therefore a need for a more flexible surveillance solution. Furthermore, the flexibility of movement of CCTV cameras is often more limited than desired, or the type of camera used at a particular location does not meet all of the desired requirements in terms of its functionality.

### SUMMARY OF THE INVENTION

The present invention relates to a deployable unit such as may be useful for surveillance, security and enforcement applications. The unit may be comprised of a vehicle or container. The advantage of this arrangement is that it is flexible and can be deployed to meet temporary requirements, changing requirements, and can be easily equipped to meet differing roles.

The present invention provides a deployable surveillance, security and/or enforcement unit configured for deployment at surveillance, security and/or enforcement locations, the unit comprising at least one but preferably two or more removable modules having equipment for performing surveillance, security and/or enforcement operations, wherein the unit has a housing with one or more openings for receiving the modules into the unit. The unit may also be considered to be a transportable building or cabin, with ruggedised faces or housing. The unit can be transported to the desired location at which surveillance, security and/or enforcement is required. If multiple modules are included they may be configured for performing different functions and are sized to allow an operator inside to perform the required functions.

In one embodiment the present invention provides a deployable surveillance, security and/or enforcement system, comprising: a deployable surveillance, security and/or enforcement unit configured for deployment at a surveillance, security and/or enforcement location, the unit comprising at least one but preferably two or more removable modules having equipment for performing surveillance, security and/or enforcement operations and the unit having a housing with at least one opening for receiving the modules into the unit; and one or more bogies, each bogie comprising a chassis, wheelset and a pair of continuous tracks, each of the continuous tracks formed of linked track plates and the continuous tracks driven by one or more wheels of the wheelset, the bogie detachably coupled to the deployable surveillance, security and/or enforcement unit. The bogies with tracks provide greater manoeuvrability over a larger range of surfaces than wheeled bogies. The removability of the bogies themselves from the unit allows the unit to be lowered and sited on the ground.

The bogie may comprise a rotatable coupling for coupling to the unit. The rotatable coupling may comprise an inner ring and outer ring. The inner ring may be configured to rotate inside the outer ring. The inner ring may be coupled to the bogie and the outer ring may be detachably coupled to the unit. The tracks, chassis and wheelset are configured to rotate with respect to the unit by the rotatable coupling.

The bogie may further comprise a pair of electric motors. Each of first and second tracks of the pair of tracks may be configured to be driven by a respective electric motor.

The bogie may comprise batteries for powering the electric motors, and or the unit may comprise a source of electrical power, such as a generator, and the electric motors may be configured to receive electrical power from the source of electrical power on the unit via detachable connectors.

The detachable connectors may also be configured for providing to the motor communications from the unit. The detachable connectors may comprise a bogie connector and unit connector which connect together, and the bogie connector may be located inside the inner perimeter of the inner ring.

The system may comprise two bogies. A first of the two bogies may be detachably coupled towards a first end of the unit and a second of the two bogies may be detachably connected towards a second end of the unit, such that the unit is supported by, and movable by the two bogies.

Embodiments of the present invention further provide a deployable surveillance, security and/or enforcement unit configured for deployment at surveillance, security and/or enforcement location, the unit comprising: at least one but preferably two or more removable modules having equipment for performing surveillance, security and/or enforcement operations, wherein the unit has a housing with one or more openings for receiving the two or more modules into the unit, and the unit comprises lifting jacks configured to lift the unit above ground level.

Each of the lifting jacks may be a screw jack comprising a leg extendable from the unit and driven by a drive device such as a motor or pneumatics.

The lifting jacks may be respectively mounted at corners of the unit.

The unit may comprise pillars at the corners of the unit. The unit may also comprise one or more doors for opening or closing the one or more openings. The pillars may be configured to pivotably support the doors. Each pillar may be further configured with one of the lifting jacks such that a leg of the lifting jacks is configured to extend from and retract into the base of the pillar.

The unit may further comprise a controller configured to set the extension or retraction of the lifting jacks. The controller may be configured to drive the lifting jacks independently or collectively.

Each lifting jack may comprise a position encoder and the position encoder is configured to: provide to the controller an indication of the vertical positions or amount of extension or retraction of the lifting jack from the unit; and/or to receive from a controller an indication of the amount of extension, retraction or movement of the lifting jack required and to perform the required movement of the lifting jack.

Each lifting jack may be configured with a laser measurement device for measuring a distance from the unit, such as the base of the unit, to the ground.

The unit may comprise a gyroscope configured to provide an indication to a controller of the inclination of the unit, and the controller may be configured to drive the lifting jacks to level the unit. The controller may also use the indications from position encoders and laser measurement devices to determine the amount required to move the lifting jacks.

The unit may be a square or rectangular shape with first sides longer than second sides, and lifting jacks may be provided at each of the four corners of the unit.

The unit may further comprise two further lifting jacks at mid-points along the long sides of the unit. These extra two jacks may be provided if the unit is longer and requires support at the middle.

Embodiments of the present invention provide a deployable surveillance, security and/or enforcement unit configured for deployment at surveillance, security and/or enforcement location, the unit comprising: at least one but preferably two or more removable modules having equipment for performing surveillance, security and/or enforcement operations, wherein the unit has a housing with one or more openings for receiving the two or more modules into the unit, and the unit comprises an air-conditioning system configured to receive air external to the unit and supply heated or cooled air to the removable modules. The air-conditioning system may be a system that is configured to receive external air to cool or heat a heat exchanger system for cooling or heating air recirculated to the two or more removable modules, or the air-conditioning system may be a system configured to receive external air which is then filtered, and optionally cooled or heated, and supplied to the two or more removable modules. Alternatively, the air conditioning system may be configured to perform both types of operation.

The unit may comprise two air-conditioning systems of which a first air-conditioning system is configured in the unit to receive or take-in external air from a first side of the unit and the second air-conditioning system is configured to receive or take-in air from a second side of the unit opposite to the first side. For example, the air-conditioning systems may have fans to draw or suck air in from outside the unit, such as for cooling or heating a heat exchanger and/or for supplying external air to inside the unit. By having separate systems configured for taking in air from opposing sides of the unit, if one side becomes buried in a sandstorm or snow drift the air-conditioner at the other side may perform air-conditioning. This also applies if the air intakes become blocked for these or other reasons.

The unit may comprise four air-conditioning systems of which first and third air-conditioning systems are configured in the unit to receive or take-in external air from a first side of the unit and second and fourth air conditioning systems are configured to receive or take-in air from a second side of the unit opposite to the first side.

The unit may comprise a controller configured to control the four air-conditioning systems such that if either of the first and second air-conditioning systems fail, the respective one of the third and fourth air-conditioning systems receiving air from the same side of the unit is brought into operation to supply air-conditioned air to the removable modules.

The controller may be configured to control the four air conditioning systems such that if the first and third air conditioning systems on first side of the unit are blocked or unable to receive or take-in external air, the second or fourth air conditioning system is brought into operation to supply air-conditioned air to the removable modules.

The unit may comprise air intake ports in the roof or at the top of the walls of the housing of the unit to receive or take-in external air for the air-conditioning systems and each system has a separate intake port.

Embodiments of the present invention provide a deployable surveillance, security and/or enforcement unit configured for deployment at surveillance, security and/or enforcement location, the unit comprising: at least one but preferably two or more removable modules having equipment for performing surveillance, security and/or enforcement operations, wherein the unit has a housing with one or more openings for receiving the two or more modules into the unit, and the unit comprises a retractable satellite antenna at the top of the housing.

The housing may comprise pillars at the corners of the unit, such as for supporting doors of the unit, and the satellite antenna is configured to fold-up and retract into one of the pillars. If the antenna is a dish then the dish itself may fold, whereas if the antenna is a more linear aerial shape then it may simply retract.

Embodiments of the present invention provide a deployable surveillance, security and/or enforcement unit configured for deployment at surveillance, security and/or enforcement location, the unit comprising: at least one but preferably two or more removable modules having equipment for performing surveillance, security and/or enforcement operations, wherein the unit has a housing with one or more openings for receiving the two or more modules into the unit, and the unit comprises a door system. The door system may comprise first and second doors that are configured together to move to open and close a first opening of the plurality of openings. The first door may be mounted to the housing for pivoting movement to open and close a first portion of the first opening and the second door may be mounted to the first door to translate linearly with respect to the first door between retracted and extended positions. In the retracted position the second door is retracted against or into the first door opening a second portion of the first opening. In the extended position the second door closes the second portion of the opening.

The second door may be mounted to slide on one or more tracks or rails for retraction and extension. The second door may slide on the tracks or rails or may have rollers to roll along aid movement along the tracks or rails

The second door may be mounted to retract into, and extend from, a cavity in the first door to respectively open and close the second portion of the first opening.

The second door may be mounted on a track or rail extending into the cavity of the first door.

The first door may have track extending into the cavity, which when the first door is in the closed position, aligns with a track in the base of the housing at the second portion of the first opening. With first door in the closed position, the second door may be configured to translate from the cavity in the first door along the track in the base of the housing to close the second portion of the first opening. Tracks or rails may also be provided at the top of the cavity and opening also for guiding opening and closing of the second door.

The second door may have a height less than the first door to fit inside the cavity of the first door.

The second door, when in the retracted position, may not extend beyond the cavity of the first door. In other words it may be substantially concealed in the cavity.

The housing may comprise a pillar and the first door may be arranged to pivot at the pillar.

The pillar may be at a corner of the unit.

The pillar may comprise a motor arranged to drive pivoting rotation of the first door to move the first door between open and closed positions.

The housing may comprise a second pillar, and the second door, in the extended position, may extend into a groove in the second pillar.

The unit may have a rectangular shape with first sides longer than second sides. The door system opens and closes the first opening which may be in a first side. The unit may further comprise a second door system arranged to open and close a second opening in the first side.

Embodiments of the present invention provide a deployable surveillance, security and/or enforcement unit configured for deployment at surveillance, security and/or enforcement location, the unit comprising: at least one but preferably two or more removable modules having equipment for performing surveillance, security and/or enforcement operations, wherein the unit has a housing with one or more openings for receiving the two or more modules into the unit, and the unit comprises a fire suppression system configured to suppress fires in the two or more removable modules and outside the modules but in the housing of the unit.

The unit may comprise bays for receiving the removable modules. Each bay may be sized to receive a module of a first size. Optionally, two adjacent bays together may be configured to receive a module of a second size greater than the first. The fire suppression system may comprise a connector in each bay for connecting to the module in the bay and each module comprising a fire suppression device. Bays also be known as slots, recesses or compartments, although they may not be divided by separating walls until the modules are inserted.

The housing may comprise a plurality of fire suppression devices connected to the fire suppression system.

The fire suppression system is a first fire suppression system and the unit may further comprise a second fire suppression system to suppress fires in the two or more removable modules and in the housing of the unit.

The connectors are first connectors and the fire suppression devices are first fire suppression devices, and the unit may further comprise a second fire suppression system. The second fire suppression system may comprise a second connector in each bay for connecting to each module in the unit and each module may comprise a second fire suppression device. The housing may comprise a plurality of second fire suppression devices connected to the second fire suppression system. Optionally, the unit may further comprise a controller configured to control the first and second fire suppression systems such that if the first fire suppression system fails the second fire suppression system is activated or put on standby ready to attend to fires if detected.

The fire suppression devices in the modules may be configured to act independently of fire suppression devices in other modules, whereas the fire suppression devices in the unit for protecting the unit itself may act together such that if one fire suppression device at one end of the unit detects a fire then that and all other fire suppression devices supply fire suppressant.

The connectors are configured to connect the fire suppression system to the modules when the modules are received in the housing.

Embodiments of the present invention may be combined. For example, embodiments relating to the doors may be combined with embodiments relating to the lifting jacks. Various other combinations are also possible.

The invention provides surveillance security and enforcement management. The system removes reliance on finding the right initial location for a surveillance vehicle through an inherently flexible solution using robotics. The system removes reliance on human intervention to detect, report and/or trigger action against threats, and can be left unmanned for long periods of time with a remote (e.g. 4G) link back to a central headquarters (HQ) team and private secure cloud.

Performance of security, surveillance and/or enforcement operations is enhanced and/or risk reduced (or eliminated) by automated detection and reporting (for example, automatic facial recognition or heat signature detection).

The solution provided herein is future-proofed and flexible. A robotic arm is provided which can switch between detection tools. Furthermore, as new technology emerges new tools can be added and software upgrades issued to meet requirements. The capability provides for up to six tools to be available on board for the robotic arm to use. The tools are stored in bays.

Secure automation response via interchangeable robotic modules, as follows:
Anti-Terrorism modules;
Radiation, Biological and Chemical detection modules; and
Flexibility to develop additional functions to be added to the system: interchangeable module options.

The system can be used to perform a multitude of tasks, including the surveillance and collecting of data via modules attached to the robotic system management equipment. A cabin located at the back of this system serves as a mobile command centre and communications hub for the security vehicle and equipment.

The present invention provides a surveillance, security and/or enforcement unit comprising a robotic arm, the robotic arm having at least six axes of movement and comprising a base and an end effector. The base is coupled to the module unit and the robotic arm manipulated to perform the requested surveillance, security and/or enforcement functions, wherein the surveillance, security and/or enforcement unit is configured for deployment from a vehicle or detachable flat-bed.

The six axis robotic arm has the advantage of greater manoeuvrability such that a surveillance device can be positioned to look around objects which would normally block a view. The arm may even be used to look around corners. Furthermore, the end effector provides flexibility in the type of camera or other surveillance device employed for the situation.

The following components are considered to provide the unique advantages of this system:
Robotic arm to cover near-field with cameras and/or other detective tools;
Robot system (such as ABB YuMi robot) allows for a complete unmanned diagnostic sampling system; and
Autonomic drones (UAVs) to cover an expanded field of 3 to 16 km around the system/unit, the drones equipped with cameras and/or detective tools.

The system may be locked on a removable trailer for long-term surveillance such as at venues. This allows the truck to be used on another assignment.

The invention provides a method as follows:
Step 1: Detachable unit (container) allows the system to be deployed from a “heavy lifting” helicopter. Then the unit's function(s) can be used (unmanned) to assess an area before personnel are deployed into the assigned area.
Step 2: The robotics system uses the preloaded modules to assess the situation (remotely and unmanned). The modules provide: radiation detection, biological detection, chemical detection, video surveillance via a plurality (10) of surrounding cameras and a robotic camera module, and video surveillance via drone deployment, retrieval (recharging via the unit).
Step 3: All communications streaming back to headquarters (HQ).
Step 4: Once the all clear has been given, human resources are deployed with the unit becoming the command centre.

The present invention provides a deployable surveillance, security and/or enforcement unit, comprising: a container configured for deployment from a vehicle or by air at a surveillance, security and/or enforcement location; and two or more removable modules having equipment for performing surveillance, security and/or enforcement operations, wherein the container has a housing with at least one opening for receiving the two or more modules into the container. The unit may be a building that may be temporarily deployed to a location, a vehicle, part of a vehicle, or a trailer. In some cases the unit may be deployed long term. Although it is preferable that there are two or modules, in some embodiments one or modules may be used. Preferably, the container is sized for human occupancy, and may a shipping container. Security and surveillance includes monitoring for any threats or dangers, such as to human health or the safety of infrastructure. Enforcement may mean, for example, identifying speeding cars or crime.

The two or more removable modules may comprise any two or more of the following: a command module for controlling other modules in the unit and/or sending communications to a remote location; a reconnaissance module for performing reconnaissance of the environment surrounding the unit; a sampling and diagnostic laboratory module for testing samples for chemical, biological, radiological and/or nuclear species; a decontamination module comprising a washroom for decontamination of personnel and/or equipment; and a utilities module for providing utilities and/or communications services to other modules in the unit. As mentioned above, in less preferred embodiments one or more modules may be used. The sampling and diagnostic laboratory may also be known as a sample testing and diagnostic laboratory, for example, if samples are collected by apparatus not forming part of the module. The utilities module may provide or supply power, include air conditioning apparatus for air-conditioning the modules, and may also include communications equipment for transmitting and receiving communications between the modules and external locations by wired or wired connection. The container may comprise doors for opening for receiving the one or two or more modules. In a preferred arrangement, the doors are arranged such that at least one complete face of the container can be opened to form the at least one opening for receiving the one or two or more modules.

Each of the modules may comprise lifting pads for receiving the forks of a fork lift truck for lifting the module into the container.

The container may be adapted to be deployed at a surveillance, security and/or enforcement location by air from a helicopter.

The container may be provided in accordance with one of the following: configured without wheels for deployment by air; configured without wheels for deployment from a land vehicle by crane; configured with wheels as a trailer for land based deployment by being towed; or configured with wheels and motive drive to be deployed by driving.

The container may have ruggedized metal faces, for example to withstand attack by persons or crowds. The container may be a shipping container modified for installation of the modules. The container may have tracks or rails fixed to the floor of the container to guide the loading of modules into the container.

The container may comprise a plurality of cameras for monitoring the surroundings of the unit. The cameras may be mounted on the container.

One of the two or more modules may be a reconnaissance module and may comprise at least one of: a robotic arm configured to move a surveillance, security and/or enforcement device to a position to monitor a target location proximal to the unit; and an unmanned aerial vehicle for launching from the reconnaissance module for performing surveillance, security and/or enforcement activities remote from the unit. The target location may be at a distance from the device.

The one of the two or more modules may be a reconnaissance module and may have a robotic arm comprising a base and an end effector, the base may be coupled to the reconnaissance module, the end effector may be arranged to receive one of one or more surveillance, security and/or enforcement devices and the robotic arm may be configured to move the device to a position to monitor a target location.

The deployable surveillance, security and/or enforcement unit may further comprise an array of docks or docking ports for receiving and storing the one or more surveillance, security and/or enforcement devices, wherein the robotic arm may be configured to manoeuvre the end effector towards the dock array to engage one of the surveillance, security and/or enforcement device.

The surveillance, security and/or enforcement devices may comprise two or more devices having different functions, the functions include at least two of: a camera configured for collecting images and performing facial recognition of persons in the images; a camera configured for collecting images and performing number plate recognition of vehicles in the image; a speed sensor for detecting the speed of vehicles passing through a target zone; and one more cameras for collecting images 360°around the unit.

One of the surveillance, security and/or enforcement devices may have multiple functions and comprises a plurality of sensors for facial recognition, number plate recognition and speed sensing, the plurality of sensors may be evenly distributed azimuthally around a central axis.

The one of the surveillance, security and/or enforcement devices may further comprise one or more cameras for collecting images covering 360°around the unit.

The surveillance, security and/or enforcement devices may comprise: one or more sensors for detecting one or more of chemical, biological, radiological or nuclear hazards.

The two or more surveillance, security and/or enforcement devices may have different functions; the functions may include one or more of: a UAV servicing application module; a chemical detection module; a biological detection module; and a camera/video surveillance module.

The base of the robotic arm may be mounted to a lifting platform for raising the robotic arm through an aperture in the roof of the container to enable a surveillance, security and/or enforcement device to monitor the target location. For example, this may be such that the device is outside of the container, and may include at least part of the robotic arm being outside the container. The lifting platform may comprise a scissor lift.

The robotic arm preferably has six-axes of movement.

The robotic arm, at full extension, may be longer than the width of the container and is arranged to extend to move the surveillance, security and/or enforcement device to a position beyond the width extent of the container. For example, this may be so as to be able to view or sense around a building, tree, or other object, or for example to see around a corner. In some arrangements this may be possible with a shorter robotic arm.

The deployable surveillance, security and/or enforcement unit may further comprise one or more drones or unmanned aerial vehicles (UAVs) for launching from the reconnaissance module for performing surveillance, security and/or enforcement activities remote from the unit.

The container preferably has an aperture in the roof through which the UAV or drone may be launched.

The reconnaissance module may comprise a landing pad on which the UAV is stationed prior to launch, the UAV is powered by a battery and the UAV is adapted to recharge the battery when on the landing pad.

The drone or UAV may further comprise a camera or sensors arranged for collecting surveillance, security and/or enforcement data. The UAV may comprise a memory and a processor configured to be programmed to control the UAV to fly a predetermined flight route and collect surveillance, security and/or enforcement data. The UAV may be configured to be controlled or flown from a command module in the unit or from a control centre at a remote location.

The reconnaissance module may comprise a plurality of UAVs and the plurality of UAVs may be stored in the reconnaissance module in a drawer system, each drawer may comprise a landing pad for a UAV, each drawer may be arranged to slide in and out of a cabinet of the drawer system, the drawers when in a closed position in the cabinet are arranged vertically above each other. The container may have an aperture in the roof for launch of the UAVs, the aperture positioned above the position corresponding to that of an open drawer of the drawer system. The drawers of the drawer system may be configured as cassettes, for example in tower storage.

One of the two or more modules may be a sampling and diagnostic laboratory module comprising test equipment for testing for chemical, biological, radiological, and/or nuclear species, for example, for hazardous species.

Closing all doors of a module or container may seal the module or container.

The container may comprise an aperture in the roof, and the sampling and diagnostic laboratory may comprise one or more unmanned aerial vehicles (UAVs) for launching through the aperture in the roof of the container, the one or more UAVs comprising apparatus for sampling an environment around the UAV. The environment for sampling may be the atmosphere, air, or a surface in the surroundings that the UAV can fly to, and or land on if a surface

The sampling and diagnostic laboratory may further comprise a robot programmed to take the environmental sample from the UAV and submit the sample to a selected one of the test equipment for testing for specified chemical, biological, radiological, and/or nuclear species. The robot may be configured to be controlled from a location remote from the container. The UAV may include recharging on a landing pad, live data feeds, and/or individual flight paths as well as any other features discussed above for the UAVs of the reconnaissance module.

One of the two or more modules may comprise a washroom for decontamination of personnel from chemical, biological, radiological, and/or nuclear hazards, the washroom may comprise a tank for storing water for washing the hazard from the person.

One of the two or more modules may be a command module for controlling other modules in the unit and may comprise communications apparatus for sending or receiving communications from a remote location.

The communications apparatus may be configured for communicating with one or more other deployable surveillance, security and/or enforcement units.

The unit may communicate with other units forming a network of units at a surveillance, security and/or enforcement venue.

The present invention further provides a method of surveillance, security and/or enforcement, comprising: deploying a surveillance, security and/or enforcement unit at surveillance, security and/or enforcement location; assessing the environment surrounding the surveillance, security and/or enforcement location using automated unmanned modules provided in the unit; sending data produced from the step of assessing to a manned remote location; and deploying human resources to the surveillance, security and/or enforcement location, including human resources to operate a control module in the unit. The surveillance, security and/or enforcement unit may be that described above.

The present invention further provides a deployable surveillance, security and/or enforcement unit, comprising: a container configured for deployment from a vehicle or by air at a surveillance, security and/or enforcement location; and one or more removable or fixed modules having equipment for performing surveillance, security and/or enforcement operations.

Detailed embodiments of the present invention may further provide surveillance, security and enforcement management that can be used to perform a multitude of tasks, including the surveillance and collecting of data via modules attached to the robotic system management equipment, for example surveillance (CCTV) cameras, facial recognition camera, speed camera, video streaming cameras, a GPS receiver, RFID reader, drone launcher, or applications developed by a third party contractor which has been configured to transmitted or receive data. A cabin serves as a mobile command centre and communications hub for the security vehicle.

These tasks as mentioned above are normally carried out in stealth so as not to be noticed by the general public.

The present invention provides a surveillance, security and/or enforcement unit comprising a robotic arm, the robotic arm having at least six axes of movement and comprising a base and an end effector, the base being coupled to the unit and the robotic arm arranged to perform a surveillance, security and/or enforcement function, wherein the surveillance, security and/or enforcement unit is configured for deployment from a vehicle or as a vehicle, at a surveillance, security and/or enforcement location. The unit may be a trailer or part of a vehicle. For example, the trailer may be detachable from a cab, drive unit, or tractor which provides the driving force to mobilize the unit and provides the ability to deploy the unit at locations. The unit may also form the load, payload or bed of a low-loader or flat-bed truck or lorry, and may be decoupled from the truck or lorry to provide a fixed non-wheeled unit after deployment at the desired location. The six axis robotic arm has the advantage of greater manoeuvrability such that a surveillance device can be positioned to look around objects which would normally block a view. The arm may even be used to look around corners. Furthermore, the end effector provides flexibility in the type of camera or other surveillance device employed for the situation.

The surveillance, security and/or enforcement unit may be adapted to engage a function module for performing the surveillance, security and/or enforcement function, and the function module comprises at least one of a video camera, stills camera, vehicle speed camera or radar. A number of modules may be stowed in the unit for interchanging on the end-effector of the robotic arm. The modules and/or various cameras may include different lenses, night vision cameras or attachments, 3D cameras and/or 360° full surroundings camera systems. The later may comprise an array of 3 or more cameras which when the data from them is combined provides a full 360° feed from the location.

The function module or surveillance data processing equipment may be arranged to perform any one or more of: facial recognition, vehicle number plate recognition, and vehicle speed determination. That is the processing maybe performed at the end-effector, in a cabin of the unit, or at a remote data processing location.

The surveillance, security and/or enforcement unit may further comprise a cabin having communication means for transmitting and receiving surveillance data from a function module coupled to the end effector and further comprising surveillance data processing equipment. The cabin also provides a space for locating personnel such that their activities and monitoring are hidden from view.

The data processing equipment may include a controller configured to control the robotic arm to position the end effector at a desired position and orientation to perform surveillance of a selected area or areas. The selected area or areas are selected based on information comprised in the received surveillance data.

A headquarters may be at a fixed location remote form the unit or in another unit.

The surveillance, security and/or enforcement unit may further comprise communication means for communicating with one or more deployable units and/or a headquarters/command centre to receive surveillance data from said one or more deployable units and/or a headquarters/command centre, and to process said received data.

The data processing equipment may include a controller configured to control the robotic arm to position the end effector at a desired position and orientation to perform surveillance of a selected area or areas. The control is preferably automated based data received, but may be manual.

The selected area or areas may be selected based on information comprised in the received surveillance data.

The surveillance, security and/or enforcement unit may further comprise a launch platform for launching an unmanned aerial surveillance vehicle adapted to communicate with the surveillance, security and/or enforcement unit.

The surveillance, security and/or enforcement unit may further comprise a safety housing or turret for at least partially enclosing the robotic arm. The safety housing or turret may be dome-shaped, spherical or cylindrical and is preferably arranged to rotate as the robotic arm rotates in the horizontal plane. The safety housing or turret may also perform a screening function for at least partially hiding the robotic arm from view when not in use.

A surveillance, security and/or enforcement system comprising: the surveillance, security and/or enforcement unit set out above, and further comprising a launch platform for launching an unmanned aerial surveillance vehicle adapted to perform surveillance of areas beyond the vision range of the surveillance, security and/or enforcement unit and communicate with the surveillance, security and/or enforcement unit.

According to the present invention, there is provided a surveillance, security and enforcement management vehicle comprising a robotic arm. The robotic arm has a base and an end effector at the opposite end, and can move about by six axes of motion. The base of the robotic arm is coupled to vehicle or vehicle removable trailer or flatbed bed comprising the vehicle. The vehicle is then able to perform a variety of surveillance, security and enforcement management functions.

The main communication and control hub is located within a cabin located on the vehicles platform, (Flatbed or trailer) which houses the robotic controller, computers and video display screens and PLC HMI (Human Mechanical Interface for PLC and robotic addition controls) and a setting area.

The vehicle has the advantage that it is able to perform surveillance, security and enforcement management functions, for example

The versatility of the six axes robotic arm means that the traffic management vehicle can be adapted for use for many different functions. A six axes robotic arm may comprise a base, a main arm, a forearm and an end effector. There are 3 couplings between these four components. Through the four components and three joints provide six independent modes of movement, or degrees of freedom. A six axes robotic arm has the advantage over other types of robotic arms of having a high speed of movement and being capable of reaching any position within the envelope of movement of the arm.

Preferably, the robotic arm is manoeuvrable in order to position the end effector in a plurality of positions inside and outside the vehicle and may by coupled to the vehicle on a guiding track to allow translational motion of the robotic arm across the vehicle, such as form one side of the vehicle to the other.

Preferably, the vehicle has a control unit which controls the robotic arm based on data received from at least one data source. The data source could be a surveillance (CCTV) cameras, facial recognition cameras, number plate recognition cameras, video streaming cameras, a GPS receiver, RFID reader, drone launcher and lander, or applications developed by a third party contractor which his been configured to transmitted or receive data sent from other security systems.

Preferably, the data source is at least one of a video camera, a GPS receiver, RFID reader, CAD software, a map or a plan received from an external command centre (Head office).

The invention further provides a surveillance, security and enforcement vehicle as set out above. The vehicle is coupled to a six axes robotic arm and further comprises a control unit. The control unit controls the robotic arm for CCTV or enforcement (Civilian or Government Contract) environment based on data received from at least one data source. Preferably, the data source is at least one of a data source could be a surveillance (CCTV) cameras, facial recognition cameras, number plate recognition cameras, video streaming cameras, a GPS receiver, RFID reader, drone launcher and lander, or applications developed by a third party contractor which his been configured to transmitted or receive data sent from other security systems. The invention provides still further a surveillance, security and enforcement management method. The surveillance, security and enforcement management method comprises controlling a six axes robotic arm coupled to a vehicle to perform surveillance, security and enforcement management function.

Finally, the invention provides a computer program as set out above to perform the surveillance, security and enforcement management method of controlling a six axes robotic arm coupled to a vehicle or vehicle removable trailer or flatbed.

Embodiments of the invention provide:

Fully automated robotic Security system configured for
Full flexibility and movement via the ABB or other six axis robotic system
Secure automation response
Interchangeable robotic modules
   Scalable for new applications
   Accuracy of 0.05-0.08 mm
   10-1500 kg (or 60-500 kg) Payload
Surveillance cabin
Removable from the vehicle allowing for a long-term static flexible surveillance and command centre
0-360 degree+ HD RealTime video streaming cameras
0-360 degree+ facial recognition cameras
0-360 degree+ (or 0-180 degree) number plate recognition cameras
0-360 degree+ (or 0-180 degree) Speed cameras
Vehicle to Vehicle data streaming
Vehicle to HQ data streaming
HQ remote offsite robotic activation
Platform for launching and landing aerial drones

The robotic system is programmable which enables integration into other applications, and allows for additional modules to be added to the system.

The system includes
Optional Mercedes Econic truck or other—for transporting the RRSP-SV system
ABB IRB (or other industrial robot) robotic system—to handle the modules assigned to surveillance application
HMI (Human Mechanical Interface) easy to use software interface (Robotic and PLC controls)
Optional truck mounted 7th axis for the SV robot—allowing for the movement of the robot left and right or down the length of the truck bed

The solution features
Automatic and automated detection of objects assigned
Able to adapt to new technologies (Programmable docking/undocking modules)
Flexibility for civilian or government contracts
Full range of robotic movement for the best application result

Further features include:
Facial Recognition
0-360Deg HD Streaming
Number Plate Recognition/Speed control

Additional Modules can be added
Data Live Feeds between vehicles/units
Remote Robotic Control (Ability to activate any module within the Surveillance)—HQ authorized
Platform for launching and landing aerial drones—HQ authorized

Surveillance unit includes
Communication Centre housed in cabin of unit:
ABB or other industrial Robot:
   Accuracy of 0.05-0.08 mm
   10-1500 kg (or 60-500 kg) Payload
Safety Robot housing:
Docking Unit (Multiple Units)
Manned or Unmanned (Run via HQ or another SV system) the robotic application are fully functional

Surveillance unit is comprised in
Removable trailer for long-term surveillance or venues. This allows the truck/motive power to be used on another assignment.

Robotic arm:
Full range of robotic motion (For safety only while the vehicle is stationary)
Docking plate allows for interchangeable module to be used for Civilian or Government contracts

Proven market need driven by
Security and surveillance
availability of significant operational and financial efficiencies for users

### BRIEF DESCRIPTION OF THE DRAWINGS

Embodiments of the present invention and aspect of the prior art will now be described with reference to the accompanying drawings, of which:

FIGS. 1a and 1b are illustrations of a modular surveillance, security and enforcement unit according to an embodiment of the present invention, shown in FIG. 1a with modules in a container and in FIG. 1b without the container;

FIGS. 2a and 2b are illustrations of the exterior of a container in which the modular units of FIG. 1b may be implemented;

FIG. 3 is an illustration of a command centre module according to an embodiment of the invention;

FIG. 4 is an illustration of a decontamination module according to an embodiment of the invention;

FIG. 5a is a diagram of a robot system for use in a sampling and testing module;

FIG. 5b is an illustration of the testing module according to the present invention, in which the robot system of FIG. 5a may be implemented;

FIG. 6a is an illustration of a reconnaissance module according to the present invention;

FIG. 6b is a diagram of a robotic arm for use in the reconnaissance module of FIG. 6a;

FIG. 7 are diagram of cameras and images tools for implementation as part of the reconnaissance module of FIG. 6a;

FIG. 8 is a schematic illustration showing methods of deployment of the surveillance, security and enforcement unit according to embodiments of the invention;

FIG. 9 is a schematic diagram showing the network and communication arrangement of two surveillance, security and enforcement units according to an embodiment of the invention;

FIG. 10 shows a side view of a surveillance, security and enforcement vehicle according to an embodiment of the present invention, in which a security vehicle performs stealth functions;

FIG. 11 shows a robotic arm coupled to a surveillance, security and enforcement management vehicle according to an embodiment of the invention;

FIG. 12 is a schematic diagram of a six-axis robotic arm;

FIG. 13 shows a six-axis robotic arm on a guiding track providing a seventh degree of freedom;

FIG. 14 shows a docking plate as the end effector and an interchangeable module according to an embodiment of the invention;

FIG. 15 is a block diagram of the main functional components of the surveillance, security and enforcement vehicle;

FIG. 16 shows a detailed rear perspective view of a surveillance, security and enforcement vehicle showing a robotic arm according to an embodiment of the invention;

FIG. 17 is a diagram showing multiple units in communication with each other and a headquarters;

FIGS. 18a and 18b respectively are side and end views of surveillance, security and enforcement unit mounted on tracked bogies according to an embodiment of the invention and FIG. 18c is a perspective view of the tracked bogie;

FIG. 19 shows side and end views of a surveillance, security and enforcement unit mounted on tracked bogies according to another embodiment of the invention;

FIG. 20a is a perspective view of a surveillance, security and enforcement unit with lifting jacks according to an embodiment of the invention, FIG. 20b is an enlarged view of the lifting jack and FIG. 20c is a view of a retracted lifting jack looking upwards under the unit;

FIG. 21 shows schematic diagrams of a retractable satellite antenna for the surveillance, security and enforcement unit;

FIG. 22 shows an alternative configuration for the doors of a surveillance, security and enforcement unit according to an embodiment of the invention; and

FIGS. 23a-c are plan views show the layout of fire suppression systems of a surveillance, security and enforcement unit and modules according to an embodiment of the invention.

### DETAILED DESCRIPTION

As set out above, conventional surveillance measures often fall short of the needs of the surveillance user by being either too costly, such as extensive permanent solutions, or provide insufficient coverage or data pertaining to a location.

The present invention provides a flexible solution that can be configured and deployed in a form adapted to the specific location and surveillance requirement.

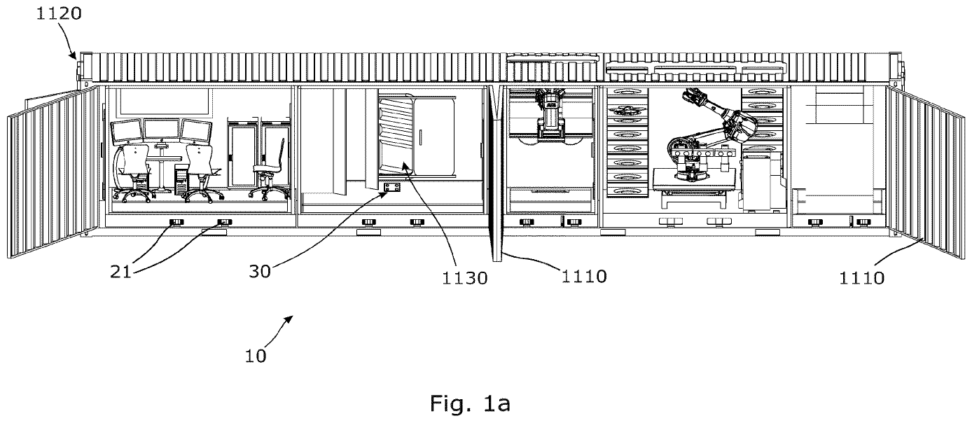

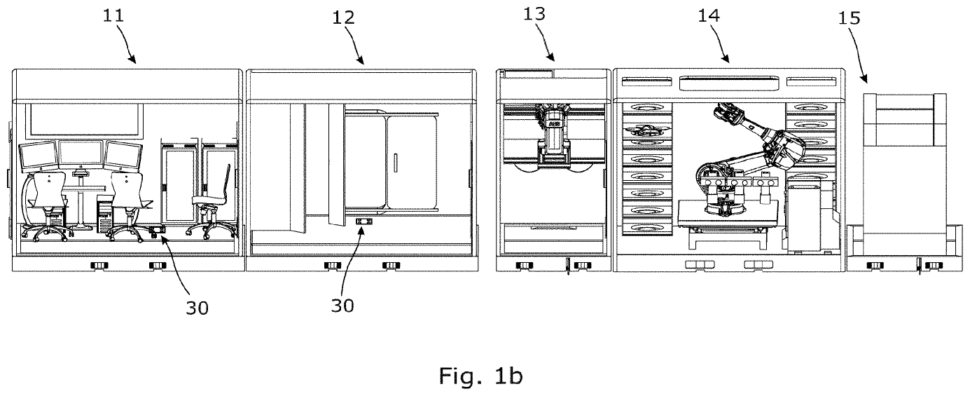

FIG. 1a shows a deployable surveillance, security and/or enforcement unit 10. The unit 10 is formed of a container, which may for example be a shipping container such as a 40 foot (12.19 metres long) shipping container. FIG. 1a shows five modules 11-15 installed in the container 10. Other numbers of modules may be installed in the container. FIG. 1b shows the modules without the container present. FIG. 1b is provided to show an unhindered view of the modules. FIGS. 2a and 2b show external views of the container 10 with doors open (FIG. 2a) and doors closed (FIG. 2b). FIGS. 2a and 2b show the front view of the container. The rear view of the container (not shown) would be similar but may have different doors or no doors at all. The container includes a housing which may be comprised of the walls, floor and roof of the container. The unit 10 has metal walls which are robust and provide strength and ruggedness. The container is preferably strong enough to be able to be stacked on top of one another, such as is usually the case for conventional shipping containers. As shown in FIGS. 1a and 2a the container 10 may include multiple doors or openings. FIG. 1a shows conceptually five modules in the container. The modules are configured to be removable. The modules are built outside of the container and subsequently loaded into or installed in the container.

Although FIG. 1a shows the unit 10 equipped with five modules, the unit can be provided with other numbers of modules as required to meet customer requirements or location demands. For example, only one of the modules, such as module 14 may be included, or two, three or more modules may be included. Preferably each of the modules included is different but it may be envisaged that multiple units of the same type may be included. Furthermore, other sizes of container may be used to include more or less modules within.

In the embodiment of FIG. 1a the five modules are all different and include: a command module 11, a decontamination module 12, a sampling and diagnostic laboratory module 13, a reconnaissance module 14 and utilities module 15. The housing of the container may be adapted to permit loading and installation (docking) of the modules within the container. For example, as shown in FIGS. 1a and 2a one or more complete side faces of the container may be fitted with doors to provide an opening for installation of the modules. The container may have the conventional two end doors located at 1120 of the container (not shown), as well as four larger doors 1110. The four larger doors 1110 together allow the full length of the long side of the container to be opened. This allows the modules to be loaded into the container, for example, by fork lift truck. It can be seen in the figures that the base of the modules is provided with tracks 21 or truck fork openings to accommodate the lifting forks of such trucks. Tracks which may comprise rails may instead be provided fixed to the floor inside the container. The rails may be provided as a pair to support each module and each module may have feet to engage or slide along the rails. The rails may aid and guide sliding of the module into the container and may also be used for fixing the module into the container. The rails may be aligned across the container such that the modules may be slid in from the side of the container. The spacing of the pair of rails may be different or the same for different sized modules, or may be adjustable. Once loaded the modules may be fixed in the container by locking pins or other fastening means.

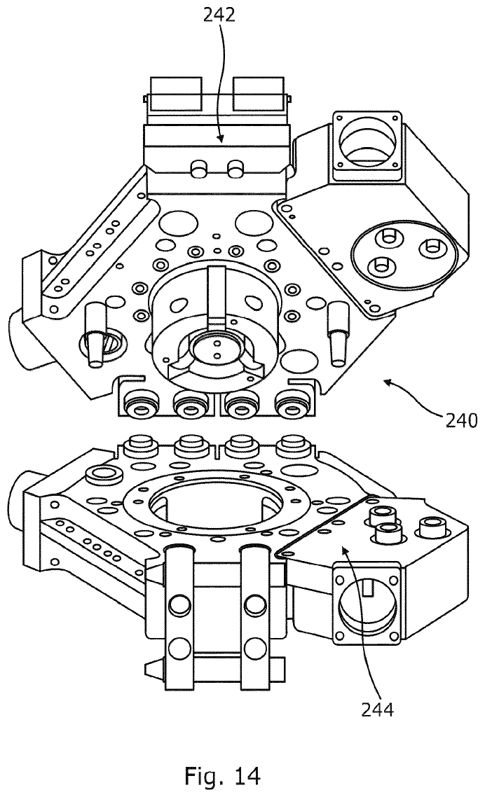

Connection of utilities to each module may be provided by a docking mechanism. This may for example be the same or similar to the docking plates shown in FIG. 14, which are described in more detail below. Such a docking mechanism may comprise upper and lower plates that engage and once engaged all required utilities are connected from the container to the module. The utilities provided may be those provided by utilities module 15, which may include power, air-conditioned air, water, and communications. Each module may comprise an upper plate 30 such as shown in FIGS. 1a and 1b in the base of the module. The container may comprise a lower plate which engages or docks with the plate 30 of the module when the module is loaded into the container.

Returning to FIG. 1a, two of the doors 1110 are hinged at the ends of the container and two at the midpoint of the long side of the container. This arrangement conveniently permits two larger size modules and three smaller size modules in each half of the container. Other positionings of the hinges are possible, and other sizes of module are possible. The container may also comprise additional openings or doors specific to the requirements of each module. For example, the container 10 may comprise an additional door for human entry into the module 12 from the rear face of the container. The actual arrangement and positioning of doors may be different to that shown in the figures.

The modules may have various sizes. For example, FIG. 1a shows five modules in the container or unit. FIG. 1b shows the five modules without the containing being shown. Modules 11, 12 and 14 are larger than modules 13 and 15. For example, modules may be available with widths of 1.25, 2.5, 3.75 and 5 metres. In FIG. 1b three 2.5 metre wide modules are shown with two 1.25 metre modules. For other size containers or units and modules many other configurations are possible. In one possible configuration (not shown) the power and communications is provided separately and the two doors of the unit allow access to 5 metres width of container or unit. With the modules sizes set out above 39 different configurations are possible.

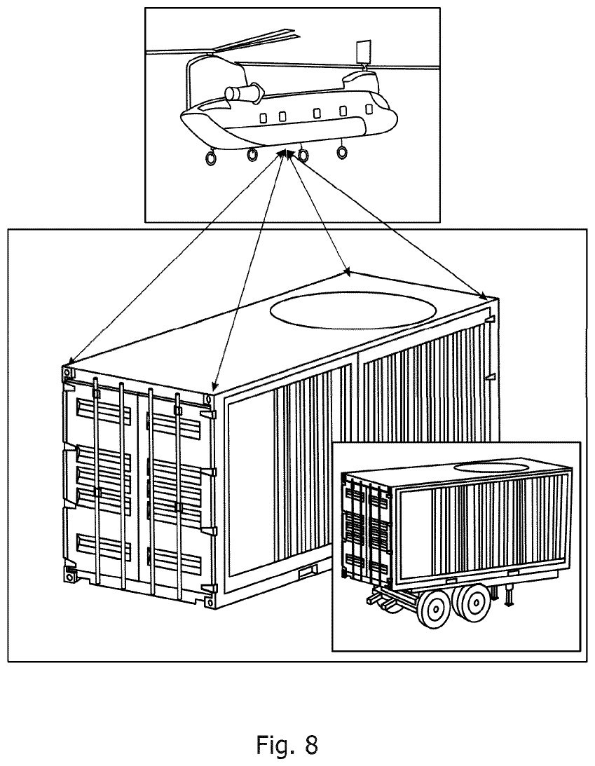

The unit 10 may be adapted to be deployed by road or air vehicle. For example, as shown in FIG. 8 the container may be equipped with lifting points on the roof of the container. These lifting points allow attachment of chains or cables which can then be attached to a lifting device. The lifting points may be lifting hooks, loops or eyes, for example, at the corners of the roof of the container or unit. In FIG. 8 a heavy lift helicopter is shown lifting a unit. Additionally or alternatively, the unit 10 may be deployed by road. As another example shown in FIG. 8, the unit may be provided as part of a wheeled trailer. Such a trailer may be towed by the motive power unit of a truck or lorry and decoupled from the motive power unit when delivered to the desired location. This allows the motive power unit to be used on another assignment. In a further alternative the motive power unit may be permanently coupled to the container as part of the unit. In a yet further arrangement the container may be delivered on a truck or lorry but lifted from the truck or lorry when at the desired location by use of a crane or other lifting means. In such a case, lifting points again will need to be provided, such as on the top of the container, for example at the four corners.

The modules are configured so that they can be removed from the container and exchanged for a different module providing different functionality. This ability to swap modules at any given time allows the unit to be redeployed in the field rapidly. As technology, such as cameras and sensing technology, improves the modules can be easily removed and replaced with upgraded modules. This ability to upgrade provides cost savings to the customer because the unit can be upgraded and used again many times.

As mentioned above, the container and modules are sized such that a plurality of modules fit within the container. Although each module may be manned or unmanned it is preferable that each module is sized for human occupation, that is, sized to accommodate a person standing. Each module may connect to an adjacent module by having doorways such that a person can walk from one module to another. Since modules are interchangeable the doorways are preferably located at the same position in each module so that when placed next to an adjacent module, the doorways are aligned. The module that is at the end of the container will have a door way that does not link to another module but this doorway can be used as a door way for accessing the modules from outside.

Preferably, that end door aligns with an external door of the container, such as one of the doors 1120 at an end of the container. At the other end of the container, the end module may have a door that is blanked off.

The modules may be sealed by closing doors between and for entry in to the modules. The sealing may be hermetic sealing or sealed to prevent hazardous materials entering, sometimes known as “hazmat” type sealing because of the suits of that name. The modules may be sealed separately or collectively in this way, so as to prevent hazardous materials entering. In the case of hermetic sealing nothing is allowed to enter or exit. The sealing of modules is most preferable for the decontamination chamber. It is also possible for other modules namely, the command module 11, sampling and diagnostic laboratory module 13, and reconnaissance module 14. However, as discussed below the sampling and diagnostic laboratory module 13 and reconnaissance module 14 may have doors for launching of drones or a door for a robotic arm to be deployed through. Hence, maintaining sealing when these doors are opened will not be possible. As discussed above, the utilities module may provide air-conditioning to the other modules. To provide “hazmat” type sealing the air-conditioning includes filtration to filter out known hazardous materials.

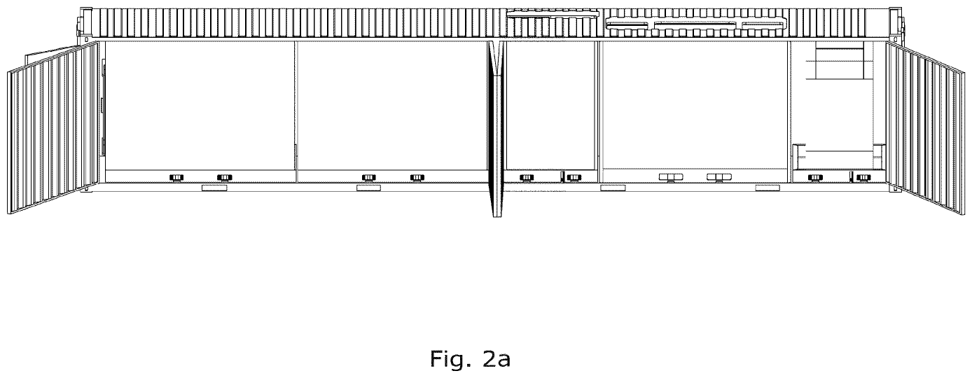

Returning to FIGS. 1a, 1b and referring to FIG. 3, the command module 11 is shown as the left most module in FIGS. 1a and 1b. The command module 11 comprises computing and data processing resources which may receive data from other modules in the unit and process the data. The command module may be configured to control resources in other modules in the unit. The unit may be manned or unmanned. If the module is unmanned the command module 11 may be controlled remotely from a command headquarters. Alternatively the command module may be controlled from another unit 11.

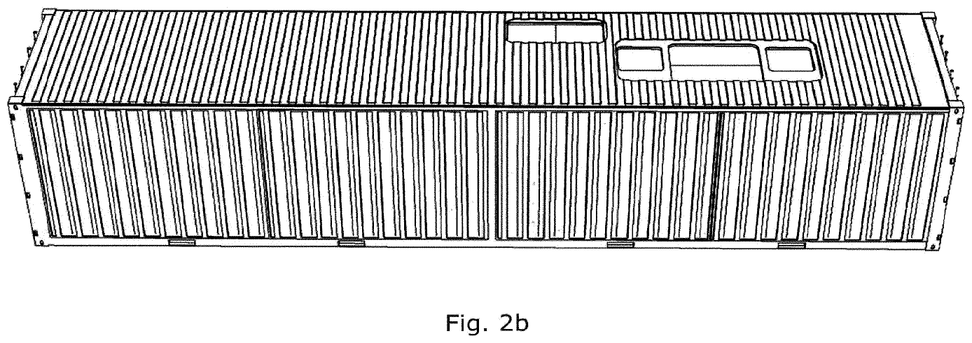

FIGS. 1a, 1b and 4 show a decontamination module 12 which comprises resources for decontaminating personnel and equipment from chemical, biological, radiological, and/or nuclear hazards which persons may have come into contact in the environment surrounding the container. The decontamination module 12 may comprise a washroom for rinsing the hazards from the personnel. The washroom may also be used for decontaminating equipment, such as portable equipment. The module may comprise a tank, such as a 1000 litre tank, for supplying fluid for rinsing. The fluid will usually be water but may be supplemented by other substances as required for the specific hazard. In some circumstances fluids other than water may be desirable. In such cases the alternative fluid may be used instead of water and stored in the tank, or a secondary tank may be used for the alternative fluid. The tank may preferably be mounted on top of the container, but may alternatively be mounted in the decontamination module or, if space permits, under the container.

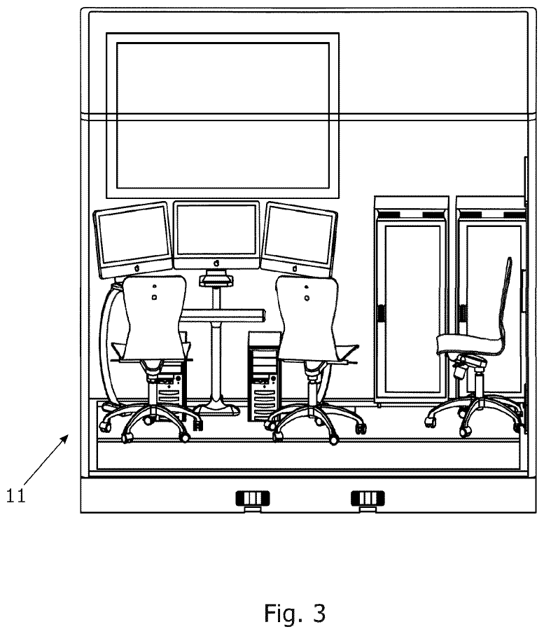

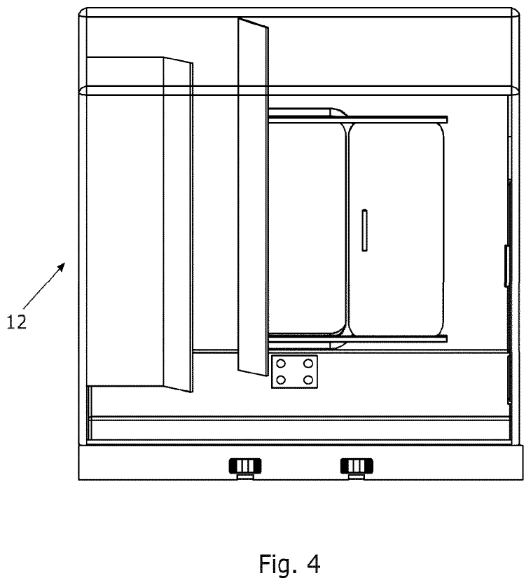

FIGS. 1a, 1b and 5b show sampling and diagnostic laboratory module 13. FIG. 5a shows a robot 22 that may be used to automate the testing performed in the module 13. The module 13 may be used for testing for samples for chemical, biological, radiological and nuclear (CBRN) species such as may be hazardous to human health or indicative of an explosive device. The module 13 is provided with test equipment to perform such testing. The module may also be provided with the robot or robotic system for manipulation of parts and equipment. The module may also comprise one or more unmanned aerial vehicles (UAVs) or drones for sampling the environment in the vicinity of the unit. The sampling may collect samples of the air or from a surface. The UAV may be launched from the module to collect samples up to the maximum range the drone can fly from the module on a single charge of its battery. This may be up to 16 km, but may also be used to collect samples close to the unit, for example when the module is unmanned. Each UAV may be programmed to follow its own flight path, which may be performed by a programmable unit on-board the UAV. Each UAV can be flown separately or individually along a specified path. In one arrangement each drone may cover a region or zone in the area surrounding the unit. The UAVs may also or alternatively be flown remotely by an operator, for example located remotely at a headquarters or an operator in a command module of the unit. As well as being able to collect samples the UAVs may also be provided with limited on board testing capability. The UAVs are fitted with radio communication means to communicate data from the on board testing back to the module 13. These communication means may include live data feeds. The module itself may also be fitted with communication means such as a radio transmitter for communicating live data to a remote headquarters.

The module is provided with a landing pad for each UAV. For example, as shown in FIG. 5b the landing pad is mounted to a wall of the module at a high level close to the test equipment. The UAVs are battery powered and the battery is automatically recharged when the UAV is on the landing pad. This automatic recharging may be achieved by the landing pad having electrical contacts which correspond with electrical contacts on the landing legs or feet of the UAV. Alternatively, a docking connector on the landing pad may be provided such that part of the UAV is guided to engage with the connector to enable recharging. In another arrangement an induction charger may be provided to transfer energy from the landing pad to the battery of the UAV. In other embodiments the battery of the UAV may be removed or unplugged from the UAV by a robot, which replaces the battery on the UAV with a charged one in an automated manner. This swapping of batteries allows the UAV to be back in service more quickly than waiting for the battery to charge. Batteries removed from UAVs may be put on charge by the robot.

The robot or robotic system 22 may be a two arm robot such as the YuMi robot from ABB. The robot is programmed to take the samples, for example in vials, on swabs or on other sample collection means, collected from the unit's surroundings and put them into the relevant testing apparatus. Once testing is complete the robot will remove them and dispose of or put the sample for storage as required. Use of the two arm robot will; enable the system to stay ahead of technology into the next century.

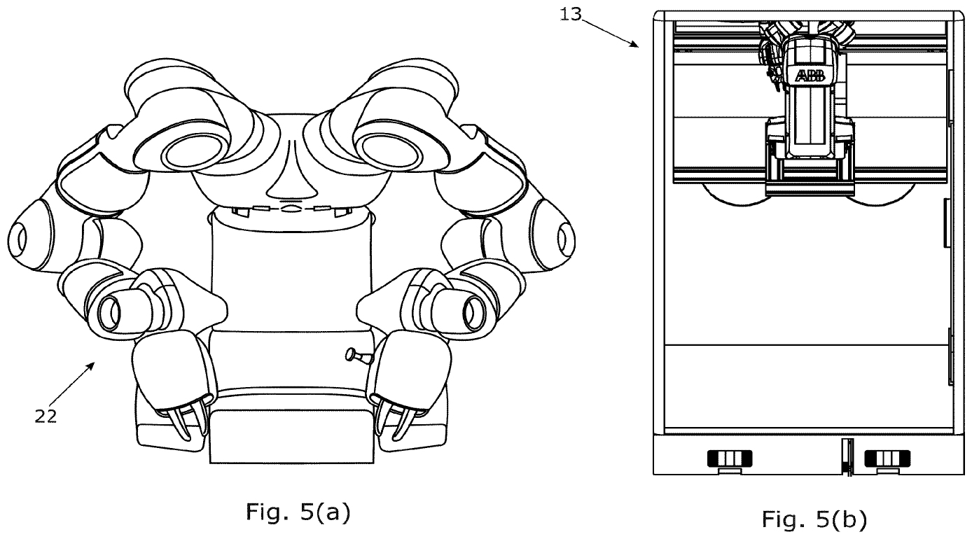

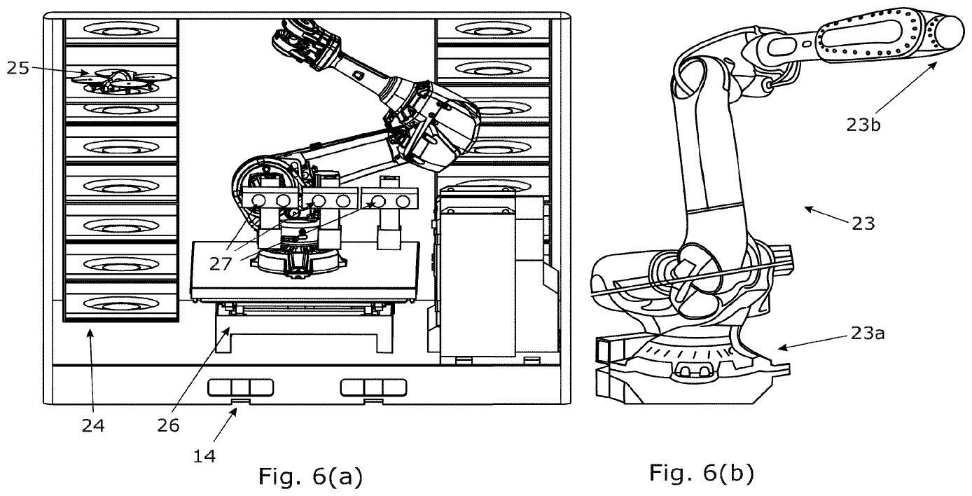

FIGS. 1a, 1b and 6 show reconnaissance module 14 which may be provided with tools for near and far-field reconnaissance from the unit. The near-field tools may comprise cameras and sensors for use with a robot arm 23. The far-field tools may be similar tools but provided mounted to unmanned aerial vehicles 25 (UAVs). In the embodiment shown in FIG. 6 there is a series of drawers 24 in a cabinet or tower store UAVs. For example, sixteen UAVs are stored in two towers of eight. Other numbers of UAVs may be stored such as 32. The drawers slide between open and closed positions. Each drawer 24 has a landing pad on which the UAV sits. When the draw is in the open position the UAV is able to launch vertically. An aperture in the roof of the container above the position of the open drawer allows the UAV to launch vertically upwards and out from the module and container to perform surveillance, security and/or enforcement activities. As set out above for the UAVs of the sampling and testing module the UAVs may be powered by a battery and may recharge the battery when on the landing pad. The options for recharging of these UAVs may be the same as set out above. The aperture in the roof of the container may comprise a door such as a motorised sliding door arranged to automatically open when the UAV is in the process of launching.

Similar to the UAVs described above they can be programmed to fly separate or individual flight paths, or may flown individually by an operator located in the command module or at a remote location. For example, each UAV may be programmed to follow its own security flight routine. Each UAV may be equipped with a camera or sensors for collecting surveillance, security and/or enforcement data. The camera may be a stills camera, video camera, heat detecting sensor or other sensor. Different UAVs may be equipped with different cameras or sensors, or depending on the payload they can accommodate multiple cameras or sensors. The UAVs may be configured to transmit data collected by the camera or sensor back to the reconnaissance module for analysis or further transmission to a remote headquarters. In some circumstances, the UAV may have a memory for storing the data such as when it is out of communications range from the module.

The UAVs 25 provide surveillance, security and/or enforcement activities at distances greater than can be provided by the cameras and sensors mounted at the module itself.

Near field surveillance, security and/or enforcement activities are provided by the robotic arm 23. The robotic arm is mounted to the module by a base 23a. The other end of the arm has an end-effector 23b for engaging with one of one or more various functional fittings as will be described later. The end-effector is the same or similar to that shown in FIG. 14 (described later) and comprises a pair of plates. The plates may be substantially the same as those described above for docking of the modules into the container. The robotic arm may have multiple axes of movement, for example six axes. A six axis robot arm may comprise two axes or movement at the base 23a or shoulder, two axes of movement at an elbow, and two axes or movement at the wrist which holds the end effector 23b. This arrangement provides a wide range of coverage of positions with high accuracy. An example of a six axis robot suitable for this purpose is the ABB IRB-6700, which has highly accurate placement (0.05-0.08 mm) such as may be required for automatic changing of the functional fitting at the end effector 23b, as well as a 60-500 kg payload for carrying heavy sensing and camera loads.

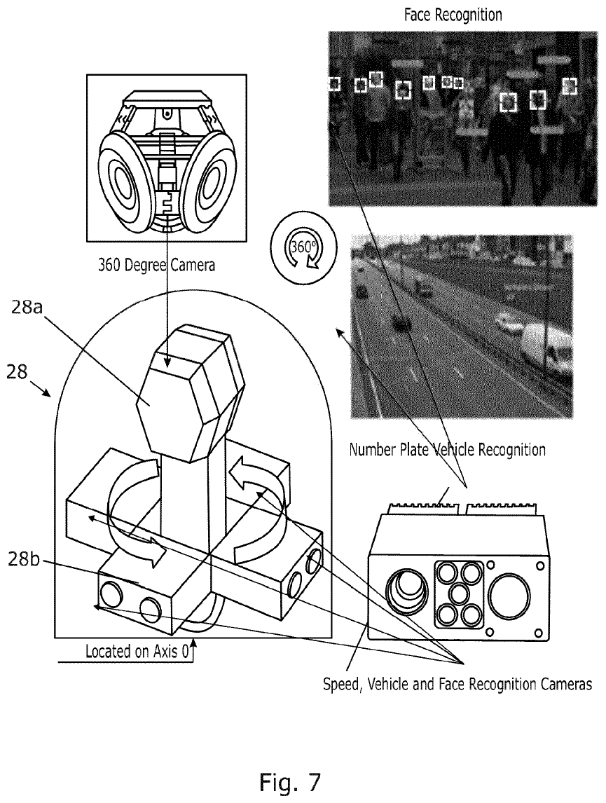

As shown in FIG. 6 the robotic arm 23 may have its base 23a mounted on a lifting device 26 to lift it such that the surveillance, security and/or enforcement device fitted at the end-effector is positioned out of, and clear from the roof of the container. As shown in FIG. 6 the lifting device 26 may lift a platform on which the base 23a of the robotic arm is mounted. The lifting device is preferably a scissor lift because this is compact and during vertical movement has minimal horizontal displacement. Other lifting devices may be used. Adjacent to the robotic arm 23 may be providing a docking unit 27 or array with multiple devices that the robotic arm can pick up. FIG. 7 shows a number of possible fittings and/or devices that may be engaged by the end effector for performing a surveillance, security and/or enforcement activity. Clockwise from top-left in FIG. 7 are shown:
i) a camera arrangement for capturing data to provide a 360° image around
the container;
ii) an example of facial recognition software processing an image;
iii) an example of number plate vehicle recognition in progress;
iv) a camera unit for speed, vehicle and face detection/recognition; and
v) a multiple camera device 28.

The multiple camera device 28 may comprise a 360° camera 28a for collecting images and is mounted on fitting member. Around the fitting member are located a plurality of camera units 28b each for speed, vehicle and face detection/recognition. These camera units are mounted equally spaced azimuthally around the fitting member to provide 360° coverage. When the end effector engages with a device the plate of the end-effector couples to a corresponding plate on the device. Once coupled communication and power are provided to the device. In the case of some modules, water or other utilities may also be provided to the device through the end-effector.

The docking unit may also comprise other surveillance, security and/or enforcement devices that can be engaged by the end-effector 23b and positioned for respective activities by the robotic arm 23. These other devices may include video or and stills cameras, and cameras for performing the functions of:
a) collecting images and performing facial recognition of persons in the images;
b) collecting images and performing number plate recognition of vehicles in the image;
c) a speed sensor for detecting the speed of vehicles passing through a target zone; and
d) one more cameras for collecting images 360° around the unit.

Devices in the docking area may also be provided with sensors for detecting chemical, biological, radiological and nuclear species in the air immediately adjacent the container, or even on the roof of the container.

A further device that may be provided in the docking unit to be used by the robotic arm 23 may be a UAV servicing application module. This device is adapted to provide servicing and/or maintenance of the UAVs. The servicing may include light servicing such as cleaning the UAV, or for example, cleaning the cameras and/or sensors or the UAV. Cleaning may be necessary if the UAVs are operating for extended periods such as 24 hour surveillance missions. The module operates by picking up a UAV or drone, for example from one of drawers 24 and cleaning the cameras of the UAV.

In a preferred embodiment four devices provided in the docking area for use with the robotic arm 23 may be:
1. UAV servicing application module;
2. Chemical detection module;
3. Biological detection module; and
4. Camera/Video surveillance module.

These four modules provide a varied range of surveillance and servicing needs to cover most, if not all, scenarios that may be required by the unit.

The robotic arm 23 is used to move the selected device into a position above the container for performing surveillance, security and/or enforcement activities of a target location. Multiple target locations may be respectively monitored by repeatedly moving the device to different reconnaissance positions. The arm may be longer than the width of the container when fully extended to allow the device held by the end effector to look around obstacles and even around corners.

The module may be linked to the unit's user interface, such as in the command module for central onsite control or may be remotely controlled from a remote headquarters location. In some arrangements the robotic arm may be controlled in real time from an operator in the command module or at a location remote to the unit. In other arrangements the robotic arm 23 may be operated by a predetermined program to perform a surveillance routine, such as when the unit is unmanned.

FIGS. 1a and 1b show utilities module 15. Utilities module may receive and distribute utilities such as power and communications to the other modules in the unit. Alternatively, each module in the unit may receive power and communications individually. The utilities module 15 may include a generator for providing power to the modules during periods that power is not received from land based power providers, such as emergency or back-up power. When, for example, due to location no land based power is available the generator of the utilities module may provide power to all modules as their main source of power. The utilities module may include air-conditioning units which providing air-conditioning to the other modules, and/or may also air-condition the utilities module itself to maintain components therein at normal operating temperatures and avoid overheating.

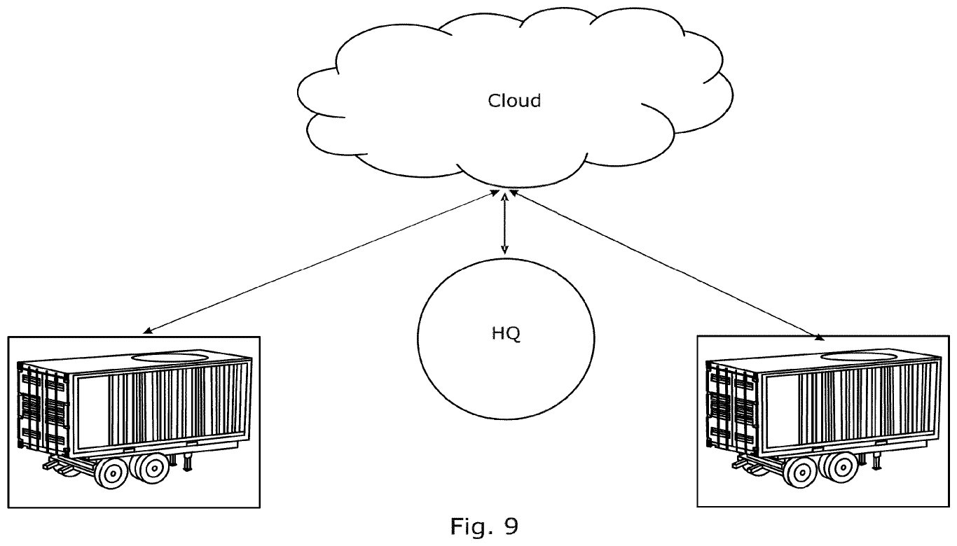

FIG. 9 illustrates an embodiment showing the communication arrangements the container may operate with. Here the container is identified as Biological & and Chemical Command Vehicle SV01. Additionally a second similar container is provided as SV01. SV02 may be provided at a location near to SV01, for example for surveillance at the same event. These containers are arranged to communicate securely via the internet and store data in secure storage accessible from the internet, such as a private secure cloud. The private secure cloud and internet link may provide:
System authorisations;
Communication;
Video streaming;
Data access; and
Remote control.

Although the figure shows two containers deployed at an event or location, any number of containers may be deployed and communicate via the internet or cloud. In particular, the containers may communicate and allow access to the above mentioned provisions to a headquarters. The headquarters may be located remotely. In one example, the containers may be deployed at an event such as a football match, with the containers located around the periphery of the football stadium or arena complex. The headquarters may be located in a building of the football stadium, or may be located at a local police station or offices of security personnel.

Each container or SV (surveillance vehicle) may have live data feeds and remote robotic control provided via the secure cloud, such as back to the headquarters or another SV. The remote control may be used to activate any module within the SV, and may be with authorisation from headquarters. The UAVs mentioned above may also be launched with authorisation sent from headquarters.

Although the embodiment of FIGS. 1a and 1b show five modules 11-15 installed in the container or unit, the present invention is not limited to this arrangement. The modular approach allows other numbers of modules to be installed in the unit, or after installation some modules can be removed before redeployment at another event. Accordingly, any one or more of the five modules described above may be included in the unit. If only one or two or perhaps three modules are required a smaller container could be used. In some instance it may be useful to include multiple modules of the same kind in the unit. Thus, the interchangeability and removability of modules, as well as the deplorability of the container provide solutions for a variety of events.

The above described embodiments provide a flexible modular approach to surveillance, security and/or enforcement equipment. However, in some circumstances the modular approach may not be required. We now describe an exemplary arrangement which benefits from many of the above features but does not require modularity. Equally parts of the embodiment described below may be implemented in the embodiment described above. In one embodiment the equipment may be built directly into the unit rather than into a module which is later installed in the container or unit. For example, if there is only one module to be fitted. In such arrangements there would not be the need for an opening in the container for loading the module through for installation.

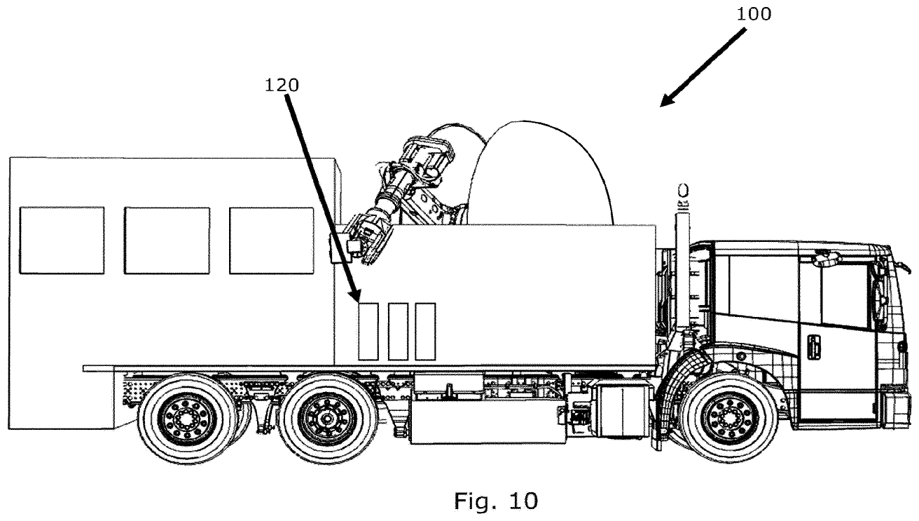

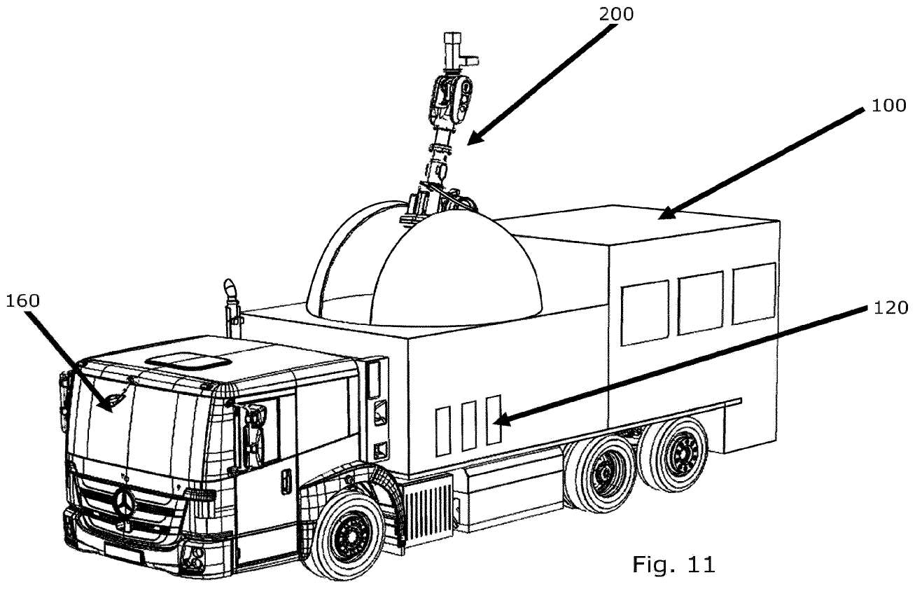

FIGS. 10 and 11 show a surveillance, security and enforcement unit 100 according to an embodiment of the present invention. The unit 100 is vehicle mounted such as on a truck, lorry or van. The unit itself may be detachable from the vehicle such that the vehicle may be used elsewhere. For example, the cab 160 or motive power may be decoupled from the unit which may be a wheeled trailer or un-wheeled load, payload or bed for example of a flat-bed lorry.

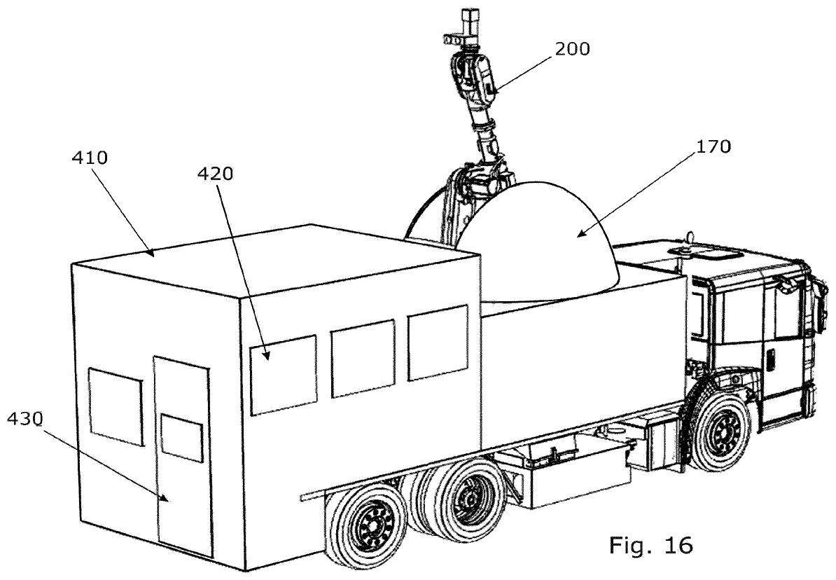

As shown in FIG. 16, the unit comprises a cabin 410 which provides space for computer surveillance equipment and processing. The cabin may be manned, or may be unmanned for remote running via a headquarters or another surveillance unit. If manned the cabin permits personnel to undertake monitoring of surveillance data such as on display screens, and may include video and sound feeds from the area under surveillance. The cabin may comprise windows 420, which may be have one-way glass for viewing out from the cabin only. The cabin may also have a door 430 to provide access into the cabin.

As shown in FIGS. 10 and 11 the unit includes a robotic arm 200 with an end effector mounted thereon. The end effector is able to select, engage, pick up and operate any one of multiple function modules 120 which are stowed in the unit within reach of the robotic arm. The function module may comprise different types of camera to perform different surveillance functions, such as those described above. More details of the different modules is provided elsewhere in this document.

The unit includes a safety housing or turret 170 which partially surrounds the robotic arm. The safety housing or turret 170 preferably moves with some movement of the robotic arm. As set out below the robotic arm has multiple axes of movement. A first axis of movement is rotation in a horizontal plane (that is, azimuth or about a vertical axis). The safety housing preferably rotates with this rotational movement of the robotic arm. The safety housing also has an aperture or slot aligned with the direction about which the elevation angle or pitch of the robotic arm can move. The safety housing provides two functions. Firstly it provides protection to persons in the vicinity of the arm to avoid collision between the arm and the person. Secondly the housing provides some visual shielding so that the view of the robotic arm and surveillance unit is partly hidden. The shape of the safety housing is preferably dome-shaped, spherical, hemi-spherical or cylindrical, such that on movement of the safety housing the spatial envelope taken up by the housing does not change.

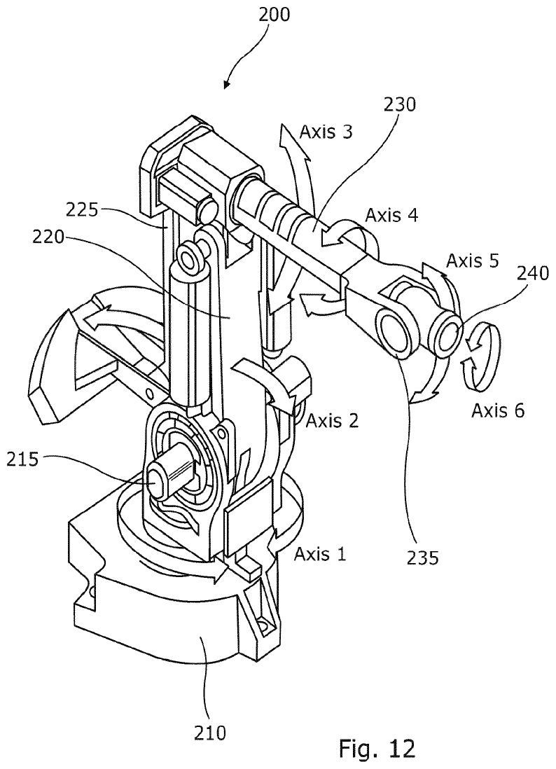

FIG. 12 shows a six-axis robotic arm 200. That is, a robotic arm that can rotate about six independent axes. This provides the robotic arm 200 with six degrees of freedom, and so the robotic arm 200 may also be called a six degrees of freedom (6-DOF) robotic arm. This robotic arm may be similar to that described above in relation to FIG. 6.

A six-axis robotic arm 200 typically comprises a base 210, a main arm 220, a forearm 230 and an end effector 240. The end effector 240 is the part of the robotic arm 200 that interacts with the outside world, and can be considered analogous to the hand at the end of a human arm. The end effector 240 is sometimes known as the end-of-arm tooling. The end effector 240 could designed for a specific task, for example a CCTV camera, or may have a multi-function purposes, number plate recognition Camera and 360 degrees streaming HD camera. The main arm 220 and forearm 230 are both sometimes called the upper arm and lower arm, depending on the orientation of the robotic arm 200. However, to avoid confusion, we shall refer only to the terms main arm 220 and forearm 230 in this description.

The main arm 220 and base 210 are connected by a joint known as the shoulder joint 215 which allows for both the pitch and yaw of the main arm 220 relative to the base 210. The pitch is the angle of the robotic arm 200 with the horizontal and the yaw is the azimuthal angle of the robotic arm 200. The main arm 220 and forearm 230 are connected by a joint known as the elbow 225 which allows for pitch and roll of the forearm 230 relative to the main arm 220. The roll is the twist angle of the forearm 230 along its axis. Finally, the end effector 240 is connected to the forearm 230 by a joint known as the wrist 235 which allows for both pitch and roll of the end effector 240 relative to the forearm 230. These parts of the robotic arm 200 are shown in FIG. 12 along with the movements allowed by each of the joints. These parts of the robotic arm 200 together allow the positioning and orientation of the end effector 240 within the work envelope of the robotic arm 200. Of course, other designs of six-axis robotic arms are possible, and the above description is merely to illustrate a typical example.

The robotic arm 200 is moved by the use of actuators or drives (not shown). These actuators are typically located at or near to the joints of the robotic arm 200. The actuators may be hydraulic, pneumatic or electrical. In general, hydraulic actuators are used for heavy payloads where power is the biggest consideration. Electrical actuators are used when there is a need for more precise control of the end effector 240, and power is of a lesser consideration.

Sensors (not shown) are distributed throughout the robotic arm 200 so that the exact position of the parts of the robotic arm 200 can be relayed to a control unit. Sensors may also be used to provide feedback to the control unit that the robotic arm 200 is close to an obstruction so that collision with the obstruction can be avoided.

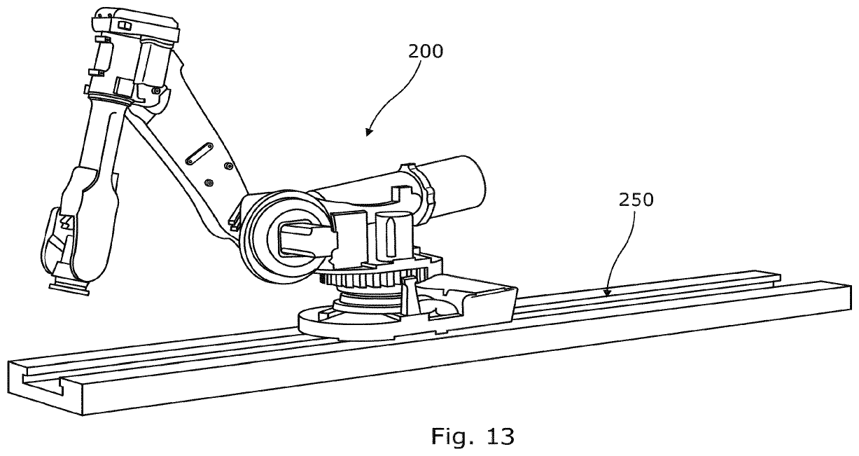

In this embodiment, in order to provide even more manoeuvrability of the robotic arm 200, the base 210 of the robotic arm 200 could be coupled to the base of the lorry 100 via a guide track 250, as shown in FIG. 13. This guide track 250 might take the form of a rail in which the base is firmly held, but which enables the base of the robotic arm 200 to move in a transverse direction relative to the length of the vehicle, or any other guide which allows transverse motion of the robotic arm 200 whilst coupling the robotic arm 200 to the vehicle 100. The addition of this seventh degree of freedom allows for a greater work envelope of the robotic arm 200. That is, the robotic arm 200 can reach further distances, and in particular can be moved from one side of the vehicle 100 to the other, or along the vehicle. By moving from one side of the vehicle to the other any objects which may block a view to the surveillance device coupled to the end effector may be avoided, so as to obtain a clear line of sight to the area under surveillance.

The surveillance, security and enforcement management vehicle 100 with robotic arm 200 can be used for variety surveillance, security and enforcement management functions. For example, the surveillance, security and enforcement management vehicle 100 could be used for surveillance (i.e. CCTV) management equipment, for example surveillance (CCTV) cameras, facial recognition camera, speed camera, video streaming cameras, a GPS receiver, RFID reader, drone launcher, or applications developed by a third party contractor which has been configured to transmitted or receive data.

In order to fulfil this multi-purpose role, the end effector 240 could be a docking plate that allows the interchangeable attachment of different modules, as shown in FIG. 14. In this figure, the upper plate 242 would form the end effector 240 of the robotic arm 200 and the lower plate 242 would be attached to whichever module is most suited for the particular function that is required. In this manner, a selection of different interchangeable modules could be kept on the vehicle to perform different functions. Whenever, the robotic arm 200 is required to perform a different task, the docking plate could be disengaged from the current module, and the appropriate module easily attached. For example, the modules could be grippers, dedicated coupling devices or video surveillance devices. The docking plate could allow the connection of any necessary facilities to the module, for example electrical, pneumatic or hydraulic connections. The modules could be changed manually by an operator, or the robotic arm 200 could change the module itself. For example, if the selection of modules were kept in a position in reach of the robotic arm 200, the robotic arm 200 could quickly and autonomously change the module to perform a desired function. It would then be unnecessary to manually change the end effector 240 to match the function that is to be performed and so reduce the workload of the operators. Furthermore, the docking plate of FIG. 14 may also be used as the docking plate or end effector for the reconnaissance module 14 described above.

As an example of invention, when the surveillance, security and enforcement management vehicle 100 is used for a variety of surveillance, security and enforcement management functions. When one device has completed its function the module 242 attached to 244 would be undocked onto a docking plate and 242 released (FREE) to pick up another assigned module.

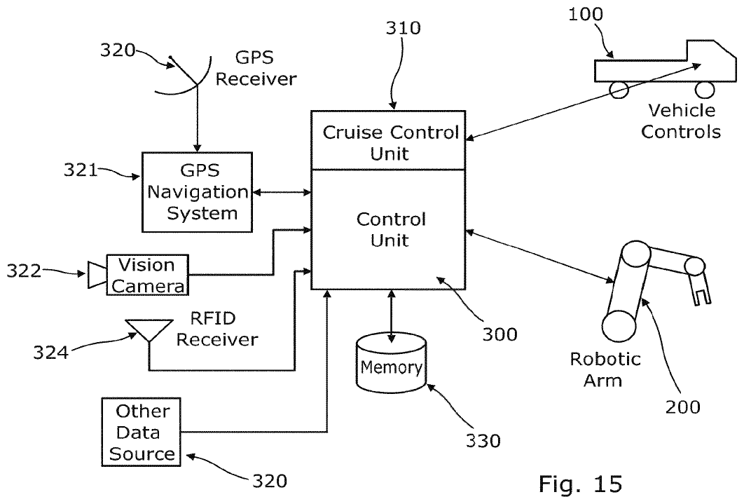

Preferably, a control unit 300 controls the movement of the robotic arm 200 as schematically depicted in FIG. 15. The control unit 300 may take data from one or more sources to determine how the robotic arm 200 is to be controlled. For example, the control unit 300 may receive data from any one or more surveillance, security and enforcement cameras 322 to provide visual data, HQ (Head Quarters) receiver 320 to provide geographic location data or data from an RFID or live feed receiver 324 regarding the proximity of an RFID device. It may further receive other forms of data from other data sources, for example CAD data, a map or other type of plan.

For example, the control unit 300 may be provided with CAD (computer aided design) or CAE (computer-aided engineering) data, designed for example using the proprietary software EPLAN, providing the desired layout of the positions of a set of area. The control unit 300 can then control the robotic arm 200 to position the surveillance, security and enforcement desired position either via the manned cabin or remotely from HQ (Head Quarters).

Other data sources may also provide data to the control unit 300 to help control the robotic arm 200. For example, machine surveillance, security and enforcement cameras could be mounted on the vehicle. The video cameras 322 may be mounted anywhere on the vehicle 100.

Alternatively, the control unit 300 may provide some signal to the driver that the desired position is out of reach of the work envelope of the robotic arm 200 or robot not in a safe position to move. The signal may provide details of how the course of the vehicle could be corrected in order to allow the robotic arm 200 to reach the desired position. For example, the signal may include an indication, either visual or audio, that the vehicle needs to be steered in a certain direction in order that the robotic arm 200 arrives within reach of the desired position.

A HD surveillance (CCTV) cameras 322 could also be mounted on the robotic arm 200, preferably on or near the end effector 240. This HD surveillance (CCTV) cameras 322 could then provide visual data to the control unit 300 regarding the position of the end effector 240 relative to the subject area of interest. In the example of retrieving data from a select target area, the visual data could be processed using machine vision techniques to provide information regarding the distance of the end effector 240 from the selected object. This would allow the control unit 300 to control the movement of the robotic arm 200 to position the end effector 240 in the correct orientation for any enforcement protocols (Civilian or Government Contracts).

The control unit 300 could be in communication with a data storage device 330 in order to store data. The data storage device 300 could be any device suitable for storing data, for example, a hard drive or flash memory. The control unit 300 could then store data relevant to the surveillance, security and enforcement management function. For example, if the surveillance, security and enforcement management module was fitted with a GPS receiver 320 to provide location of the robot position to the control unit 300, the position of the vehicle 100 could be stored. This would be especially useful when the vehicle 100 is being used to deploy surveillance (Drones) equipment as the exact position of each item of equipment could be stored with ID creating a recorded.

The surveillance, security and/or enforcement management equipment could be provided with RFID reader or receiver 324 to enable the logging of the deployment and retrieval of the traffic management equipment. For example, the control unit 300 could store the position that a particular object of interest, along with any other relevant data, for example the time and date. Then, this information could be used to enable the tracking of each item of interest.

In order to minimize the chances of the robotic arm 200 hitting anything whilst it is in operation, it is preferable to provide the surveillance, security and/or enforcement management vehicle 100 with safety features so as to reduce the chance of accidents or injury. For example, linked to the vehicle cruise control.

Other safety features that could be incorporated with the robotic arm 200 are safety cut out switches. The area in which the robotic arm 200 moves could be monitored by sensors. These sensors would be able to detect anything, especially people, that enter the work envelope of the robotic arm 200. Any area monitoring sensors could be used, for example, passive infra-red (PIR) detectors, ultrasound detectors, pressure sensors light or light beam sensors, so that if someone accidentally got too close to the robotic arm 200, the robotic arm 200 would be immediately stopped to prevent injury.

The robotic arm 200 could also be fitted with switches in order to prevent the arm from hitting parts of the vehicle, for example, the cabin 160 or the base. These switches would be activated if the robotic arm 200 tried to move to a position in which contact with a part of the vehicle was likely, and provide feedback to the control unit 300 to prevent the robotic arm 200 from moving any further.

The robotic arm 200 could be provided with its own power supply, separate from the vehicle's. The power supply would depend on the needs of the particular robotic arm 200. Typically, the power supply will provide 200-600 V AC at a frequency of 50-60 Hz, and it would be preferable to be provided as three phase. An uninterruptable power supply (UPS) could be used to prevent the sudden stopping of the robotic arm 200 whilst in the middle of an operation if the power supply failed. Optionally if the flatbed is in a stand-alone state an external supply or data connection could be used.

To explain how some of the various features of the invention may be used together, a detailed description of a specific embodiment of the invention in which the surveillance, security and/or enforcement management vehicle is used to collect surveillance, security and/or enforcement data will now be discussed. However, it should be apparent how these features could also be used in combination in a similar manner when the invention is employed in other surveillance, security and/or enforcement management roles, for example large crowded venues, Airports, Docks and Ports, or Government contracts using any of the modules previously discussed.

It should be understood that not all of the features discussed in this example are essential features of the invention, and various combinations of the features may be used depending on the circumstances.

Plan data including the desired objects or areas to be studied is loaded into the control unit 300 and stored in memory. The plan data includes GPS coordinates of the position of the start of the desired position layout. A GPS receiver 320 coupled to a GPS navigation system 321 receives these coordinates from the control unit 300 and directs the driver of the vehicle to a location near to the desired position. The control system then indicates to the driver that the position has been reached, for example via a visual display or an audio signal, so that the driver can stop the vehicle ready to start it's task.

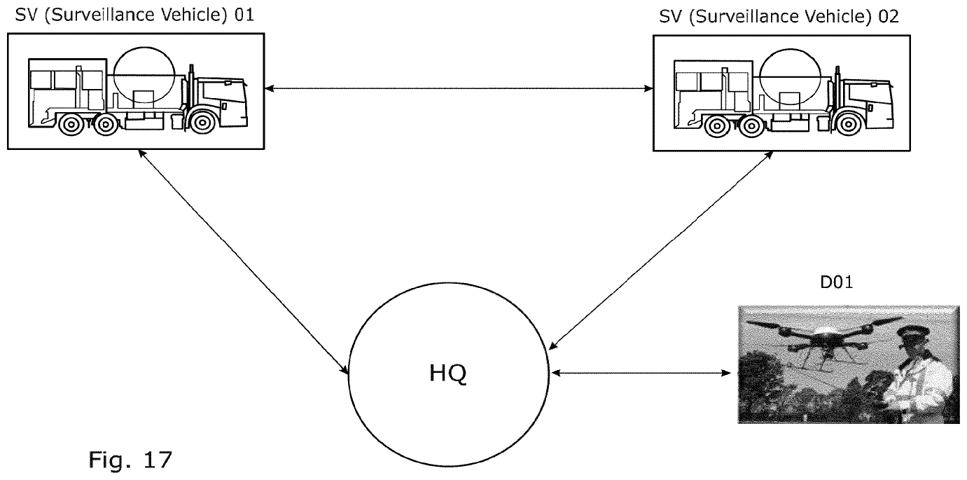

FIG. 17 shows how multiple surveillance units 100 can communicate with each other and with a headquarters or central command centre. For example surveillance vehicle SV01 may be located at a first location and surveillance vehicle SV02 may be located at a second location. More than two units may also communicate and be located at other locations. SV01 may send surveillance data wirelessly direct to SV02 and/or vice versa so the units are provided with more data than is gathered by the units alone. SV01 and SV02 may also communicate with headquarters. Command and control of the multiple units may be based in one of the units or at headquarters, to control the surveillance based on data gathered.

In a further aspect an unmanned aerial vehicle or drone can be launched, for example from a launch platform mounted on a vehicle or unit 100. The drone may provide more targeted remote surveillance in areas not accessible by the vehicles or units, For example, the drone may be used for surveillance inside football stadiums.

The multiple surveillance units 100 (SV01, SV01) together form a network of data gathering units which share information to provide a continuous and wide area surveillance capability. The inclusion of drone D01 furthers this network of data gathering.

Many other surveillance, security and/or enforcement management functions could be envisaged for the aforementioned surveillance, security and/or enforcement unit or vehicle 100 having a six axis robotic arm 200.

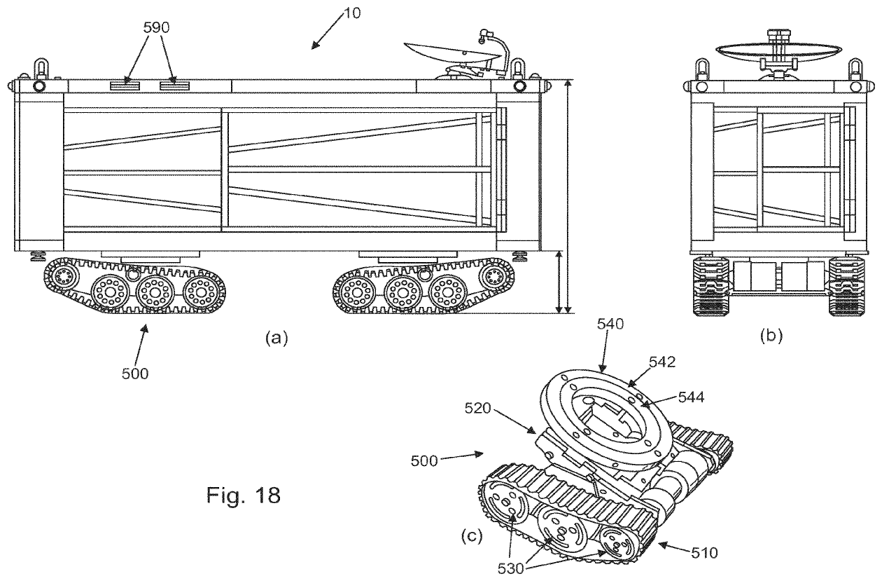

We have previously described that the unit or container 10 may be adapted to be deployed by road vehicle or air vehicle, as shown in FIG. 8. FIG. 18 shows a related further embodiment. FIGS. 18a and 18b respectively show side and rear views of a surveillance, security and/or enforcement unit or container with front and rear tracked bogies 500 attached. The tracked bogies are provided to improve the manoeuvrability of the unit such that it can be moved to a desired location more easily. FIG. 18c is a perspective view of one of the tracked bogies 500 removed from the unit 10. The bogie 500 comprises a chassis 520, wheelsets 530 and a pair of tracks 510. The tracks 510 comprise a series of track plates linked together to form a continuous loop. The chassis has a pair of wheelset or series of wheels coupled thereto, each of which supports and drives a respective track. Each track 510 may be driven by one or more or more wheels of a respective wheelset 530. The chassis is configured to couple detachably to the unit or container 10 by rotatable coupling 540. The rotatable coupling is provided at the top of the bogie. The rotatable coupling 540 allows the bogie to rotate relative to the unit 10. The rotatable coupling 540 comprises a pair of rings. An outer ring 542 is fixedly mounted to the chassis. The inner ring 544 is coupled to the outer ring but can rotate inside the outer ring. The coupling between the two rings may be by bearings that allow one ring to move relative to the other. As shown in FIGS. 18a and 18b a pair of bogies may be coupled to and may support the surveillance, security and/or enforcement unit. In FIG. 18c the coupling rings 540 are shown sloping at an angle. The couplings are movable in this way to allow them to be more easily manoeuvred under the unit as we will discuss below. Although we have described the rotatable coupling as being retained by the bogie when the bogie is not coupled to the unit, in an alternative embodiment the rotatable coupling may be retained by the unit. It is preferable if the rotatable coupling is retained by the bogies because it allows the unit, when lowered to the ground, to sit closer to the ground. Detachable coupling of the inner ring to the unit (or bogie) my be by bolts or pins.

The pair of continuous tracks 510 on a bogie 500 may be driven independently. For example, each track may be driven by one or more wheels of the wheelset. The one or more driving wheels of the wheelset may be powered by an electric motor. The bogie 500 may also comprise batteries for powering the wheels and tracks. Alternatively, when the bogie is coupled to the surveillance, security and/or enforcement unit 10, power may be supplied from the unit, for example from a generator such as a diesel generator, or solar cells on the unit. The bogie may comprise a detachable connector for connecting to the unit and receiving electrical power from the unit through the connector. The connector may be mounted to the bogie in the space inside in the inner ring 544.

The bogies include a controller for receiving control instructions for manoeuvring. Each bogie may be controlled by remote or wired connection. The two bogies may be controlled independently or in combination. For example, if the bogies are not attached to the unit they may be controlled independently but when attached to the unit may be controlled together to move the unit to the desired location.

The drive-train of the bogies are electrically driven and computer controlled (fly-by-wire). The control of the bogies may be by wired connection such as when connected to the unit. For example, a person in the unit may control movement of the bogie. Control signals may be sent to the bogies through the same connector located inside the inner ring as electrical power may be provided from the unit. Other connection options are possible. When driven by remote or wireless control this may be by a handheld controller.

The surveillance, security and/or enforcement unit may comprise integral lifting jacks which will be described later. The lifting jacks lift up the unit from the ground to permit the bogies to be driven under the unit or container 10 and coupled to the unit. Once the bogies are coupled to the unit they support the unit and the lifting jacks can be retracted. The powered bogies can then drive or manoeuvre the unit to the desired location. Once at the desired location the integral lifting jacks can be used to support the unit off the ground while the bogies are uncoupled and driven away. The lifting jacks can then be gently retracted to lower the unit to the ground.

The bogies are provided for local or limited movement of the unit. Long distance movement of the unit may be by air or road vehicle. Upon arrival close to the desired destination the bogies can be used to move the unit into position. The tracks on the bogies allow the unit to be moved across uneven, muddy or difficult terrain. The bogies may also be used for low-speed longer distance movement of the unit. The independent control of the tracks also allows the bogies to rotate on the spot under the unit such that the direction of movement of the unit can be changed with minimal lateral driving. This provides greater manoeuvrability than can be achieved by regular wheeled vehicles.

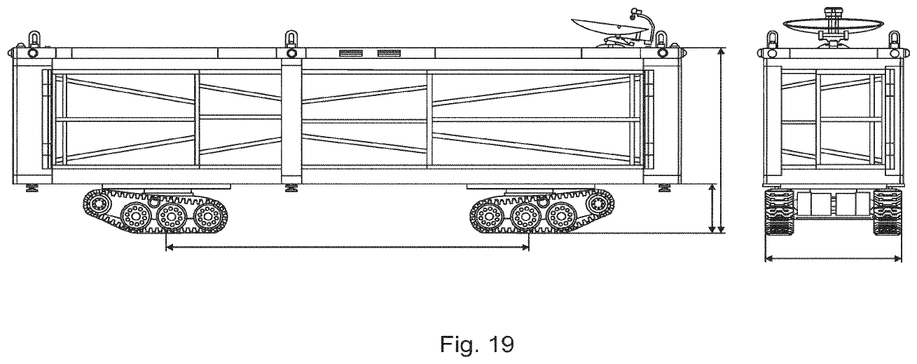

FIGS. 18a and 18b show a short version of the unit which may be 9 m in length. Here two bogies are provided on a wheelbase or centring distance of around 4.5 m. FIG. 19 shows a side view and end view of a longer unit which may be 15 m in length. Two bogies are again provided but on a longer wheelbase or centring distance of around 8 to 8.5 m. Other sizes of container may also be used.

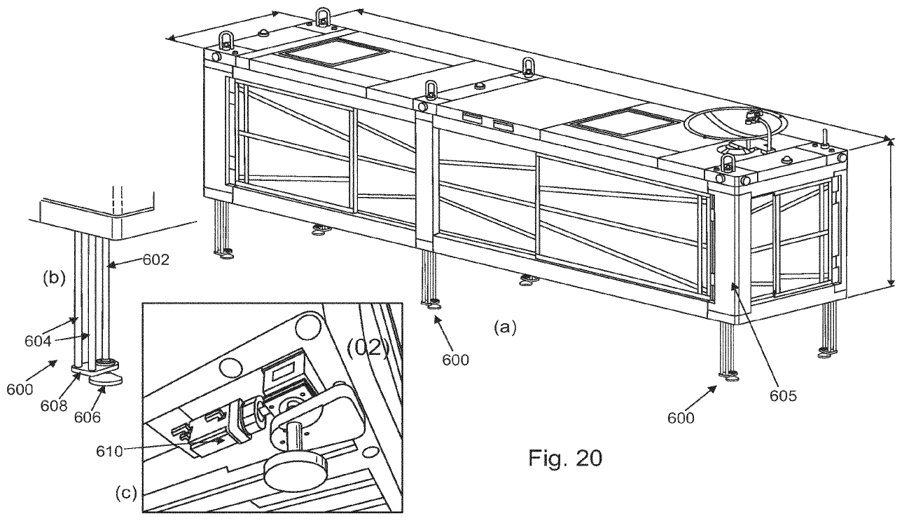

FIG. 20 shows views of integral lifting jacks for embodiments of the surveillance, security and/or enforcement unit or container 10. FIG. 20a is a perspective view of the unit showing six lifting jacks 600 with the jacks extended to lift the unit above the ground. FIG. 20b is an enlarged view of one of the lifting jacks. FIG. 20c is a perspective view from underneath of one of the lifting jacks in the retracted position.

The surveillance, security and/or enforcement unit shown in FIG. 20a has six lifting jacks. Four of the lifting jacks are provided such that there is a lifting jack at each corner of the unit. Two other lifting jacks are provided at around the mid-point of the long sides of the unit. In other embodiments only the four corner lifting jacks may be provided, or for longer units more lifting jacks may be provided along the long sides of the unit to support the weight of the unit along its length. For example, a 9 m long unit or container may have four lifting jacks with one at each corner whereas a 15 m long unit or container may have six lifting jacks as shown in FIG. 20a.

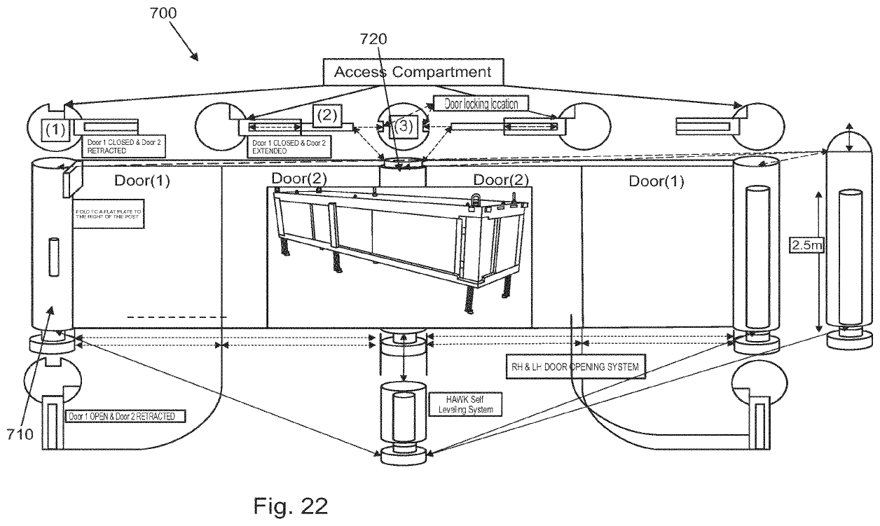

The lifting jacks 600 are integrated into the unit 10. As discussed previously in relation to FIGS. 1a and 2a the surveillance, security and/or enforcement unit may have doors that allow a large part of the long sides of the unit to be opened. Doors may also be provided at the short sides of the unit. We will describe below further door configurations shown in FIG. 22. The doors of FIGS. 1a, 2a and 22 are hinged at the ends of the unit.

Pillars in the housing of the unit support the weight of the doors. A pillar is additionally provided at the centre of the long side of the unit for the doors to close against. The lifting jacks may be provided at the corners and at the centre of the long sides and retract into the pillars.

The lifting jacks 600 may be screw jacks. For example, a jack may be mounted at the corner of the unit and may retract into the unit, such as into the pillar 605, and extend from the base of the unit to lift the unit from the ground. The jack may take the form of a leg and may be driven by a screw drive. For example, a worm screw or other type of screw may be incorporated into the leg and be driven to retract and extend it by an electric motor having a gear to engage the screw. Alternatively, the motor may drive a gear and the leg may be driven by a rack and pinion. The leg may comprise three rods 602, 604, 604 that are driven to extend from the unit. The legs may comprise a foot 606 which is the part of the leg that makes contact with the ground. The rods 602, 602, 604 meet ankle 608 which is connected to foot 606. The ankle may be a plate or block at which the rods are spaced apart. The amount of retraction or extension of the lifting jack may be determined by a position encoder. For example, the position of one of the rods 602 of the leg in the vertical direction may be measured by position encoder 610 which may be mounted to the underside of the unit. In embodiments, the device 610 may be an encoder driven motor that receives instructions from a controller to move a specified amount or to move to a specified position such as an amount of extension or retraction. The encoder driven motor on receipt of the instructions moves the required amount. A position encoder may alternatively be mounted in other places at the leg. A second device may be provided for measuring the position at the corner of the unit. A laser measurement device may be mounted to the unit to provide a measurement of the distance to the ground such as the distance from the laser measurement device or the base of the container to the ground. The laser measurement device may be provided for redundancy should the position encoder fail or for providing different/additional information than that provided by the encoder.

The unit may comprise a controller which receives data from laser measurement devices and/or transmits or receives data to/from position encoders for each of the lifting jacks. The controller may use the data to determine the vertical positioning of the unit from the ground and may control each of the lifting jacks so that they maintain contact with the ground and lift or lower the unit while maintaining it horizontal. Additionally, the unit may comprise a gyroscope for determine whether the unit is horizontal or level and provide data to the controller to adjust the lifting jacks positions accordingly. In this regard each of the lifting jacks may be controlled and driven separately to maintain the unit horizontal. Alternatively or additionally, it may be convenient to drive the lifting jacks together such as when initially lowering the unit to the ground. As the unit approaches the ground it may be desirable to maintain the unit horizontal. In such a case some of the lifting jacks may be maintained in a slightly extended position to compensate if the ground is sloping. Alternatively, if the ground is only slightly sloping the lifting jacks may be controlled to lower the unit to the ground. In each of these cases some independent control of the lifting jacks is desirable.

The lifting jacks preferably are sufficiently long that the unit can be lifted high enough for the bogies 500 to be driven underneath the unit 10 and coupled to the unit as described above. Upon arrival at the desired location the bogies are uncoupled from the unit and the lifting jacks lowered to support the unit off the ground. The bogies can then be driven away and the lifting jacks retracted to lower the unit to the ground.

Embodiments of the surveillance, security and/or enforcement unit may include air-conditioning. FIGS. 18-20 show a pair of air intakes or vents 590 for air-conditioning systems of the present invention. The air-conditioning system may be configured as an air-conditioning system that takes in external air from outside the unit, filters the air and supplies it to the modules in the unit. The filtering provided is capable of removing pathogens. Alternatively or additionally, the air-conditioning system may be configured to recirculate air in the modules and heat or cool the recirculating air by flowing the recirculating air past a heat exchanger which exchanges heat with air outside of the unit. As shown in the figures, two air intakes or vents are provided on one side of the unit. A further two intakes or vents are provided on the opposite side of the unit. The air intakes or vents take-in external air to cool the heat exchanger and/or to supply fresh air into the modules depending on the configuration or mode of operation of the air-conditioning system. The unit may have two air-conditioning systems to provide redundancy should one system fail. Each system is connected to one of the vents or air intakes on each side of the unit. The unit has air intakes or vents on two sides of the unit in case the ones on one side of the unit become blocked. For example, in dessert conditions a sandstorm may blow against one side of the unit and block the vents or air intakes on that side of the unit. In such a case air is drawn in through the opposite side of the unit. Optionally, the unit may have four air-conditioning systems with one system connected to each of the four vents or air intakes. Because the intakes are connected to different air-conditioning systems, even if the vents or air intakes on one side of the unit become blocked and one of the air-conditioning systems fails, the other air-conditioning system that receives air from the non-blocked side of the unit continues to be operational. In the figures the vents or air intakes are shown at the top of the long sides of the rectangular container. In other embodiments there may additionally be two further intakes on each of the short sides of the unit, one for each air-conditioning system. Hence, in total eight vents or air intakes may be provided for increased robustness of operation in hostile environments.

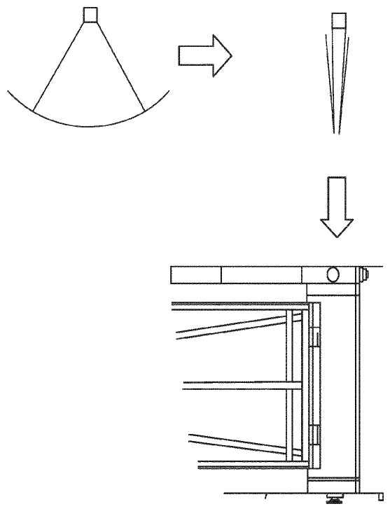

FIGS. 18-20 also show a satellite dish on the roof of the container. In FIG. 20 it can be seen that the satellite dish is pointing vertically upwards. Here the dish is shown in a stowed position in which the dish is stored because it is not in use or the The mounts of the satellite dish are rotatable and/or foldable such that the surveillance, security and/or enforcement unit is ready to be transported or moved. When it is desired to use the satellite dish mounts of the satellite dish move the dish into an operational position to receive communications efficiently from satellites in low earth orbit (LEO) or geostationary orbit. The signal transceiver is provided on an arm to receive and transmit signals at the focus of the dish. For added compactness when stowed the arm may also be folded down such that the height of the dish above the unit is minimised for transportation. Although we have shown the satellite dish in the embodiments of FIGS. 18-20 it may be combined with any embodiments herein. In other embodiments the dish may not fold down but is mounted to be able to be directed to receive/transmit communications to LEO or geostationary satellites. An alternative embodiment is shown in FIG. 21 in which the dish itself may be folded up. As shown, the dish has a receiver/transmitter which is held in position at the focus of the dish by one or more arms. The curved part of the dish itself may be folded up and the arms moved inwards. Other folding configurations are possible. After folding, the satellite dish is retracted into one of the pillars of the surveillance, security and/or enforcement unit and cannot be seen from the outside. Deployment of the dish is the reverse of retraction. A foldable satellite dish that retracts into the pillar or elsewhere of the unit results in a unit having less height which is more easily transported by road. The surveillance, security and/or enforcement unit may also have a second or more units stacked one on top of the other if a larger surveillance, security and/or enforcement system is required. Although we have described a satellite dish a more compact satellite antenna may be used if compatible with the satellite. For example, LEO satellites may communicate with an antenna which is smaller in size than a dish. Again the antenna may be configured for retraction and optional folding to be stored in the pillar of elsewhere of the unit so that it is not visible such as for transportation of the unit.

FIG. 22 shows more detail of embodiments 700 of the configuration of doors of the surveillance, security and/or enforcement unit, such as based on those of FIGS. 18-20. These doors are different to those shown in, for example, FIGS. 1a and 2a. As shown in FIG. 22 the surveillance, security and/or enforcement unit 10 has a rectangular shape such as when viewed in plan from above and hence has two long sides and two short sides. As previously discussed, the unit has doors for loading of modules there into and the doors are configured to open a substantial amount of one of the long sides of the unit. In the embodiment of FIG. 22 two combined sliding and pivoting door systems are provided. These are shown as left and right systems in the figure, each opening a substantial part of the left or right hand part of the long side of the unit. Each door system comprises two doors which are labelled Door (1) and Door (2) in the figure. Door (1) is a pivoting door and Door (2) is a sliding door. Door (2) may slide on tracks or may have rollers or wheels on the door and be moved along tracks. Door (1) is mounted for pivoting. For example, Door (1) is configured to pivot about pillar 710 in the housing at the end of the unit. Door (2) is mounted to Door (1). Together Doors (1) and (2) close a single opening in the side of the unit. To open the unit Door (2) is first retracted. Door (2) slides or rolls against or into Door (1). In a preferred embodiment, as shown in FIG. 22 Door (1) has a cavity or chamber into which Door (2) retracts. In this embodiment Door (2) retracts into the cavity in Door (1) As shown in a schematic at the top left of FIG. 22 Door (2) may retract fully into the cavity in Door (1) so that it does not extend out of Door (1). Once Door (2) is fully retracted Door (1) may be swung open on its pivot or hinged mounting. In FIG. 22 the pillar 710 about which the Door (1) moves is shown to be larger than in FIGS. 18-20. The pillar 710 has to support the weight of Doors (1) and (2) and therefore may be required to be a larger structure than shown in FIGS. 18-20.

The combination of pivoting and sliding doors may provide additional security. This is because Door (1) may not be movable until Door (1) has been opened. In the closed position Door (2) extends into a central pillar 720 of the long side of the unit. The central pillar is provided between the left hand and right hand door systems. The pillar may have a groove or slot into which the end of Door (2) locates when in the closed position. In this groove or slot various locking or bolting mechanisms may be provided to releasably lock the door in the closed position. When Door (2) is opened it slides in tracks in the base of the housing of the unit and optionally the roof of the housing. The door may slide or may be on rollers or wheels which roll in/on the tracks. Cavity or chamber in Door (1) also has tracks such that the Door (2) may slide or roll in one continuous movement into the cavity. Door (2) may be slightly shorter in height than Door (1) to fit inside Door (1). The tracks in the base of the housing (and optionally the roof of the housing) are set to a height to align with the tracks in Door (2). The tracks may prevent forced entry through Door (2) by preventing the door from be forced open in an outwardly direction off the tracks. Door (1) cannot pivotably open until Door (2) is fully retracted into it. Door (2) may be concealed into Door (1) when retracted. Although we have shown Door (2) as retracting into a cavity in Door (1) in alternative arrangements Door (2) may slide against, face-to-face with Door (1) such as against the inside face or outside face of Door (1). In such cases tracks are proved on the outside of the door.

The doors are preferably motorised. For example, pillar 710 may contain motors for pivoting opening an closing of Door (1). Optionally, Door (2) may also be motorised for opening an closing. Pillar 710 supports the weight of Doors (1) and (2) and also the weight of the motors. As the pillar supports a significant portion of the weight of the unit, this is the location for the lifting jacks described above so as to reduce bending moments when the unit is supported by the lifting jacks.

As shown in FIG. 22 the long side of the unit may have two door systems which when opened substantially open the side of the unit. The central pillar may receive in opposing grooves the ends of the sliding doors of the two systems. As well as in these grooves, bolts or locks may be provided around the edge of both doors in each system. The sliding door may have embedded along its closing edge safety lights or other devices to prevent harm to humans as the door closes.

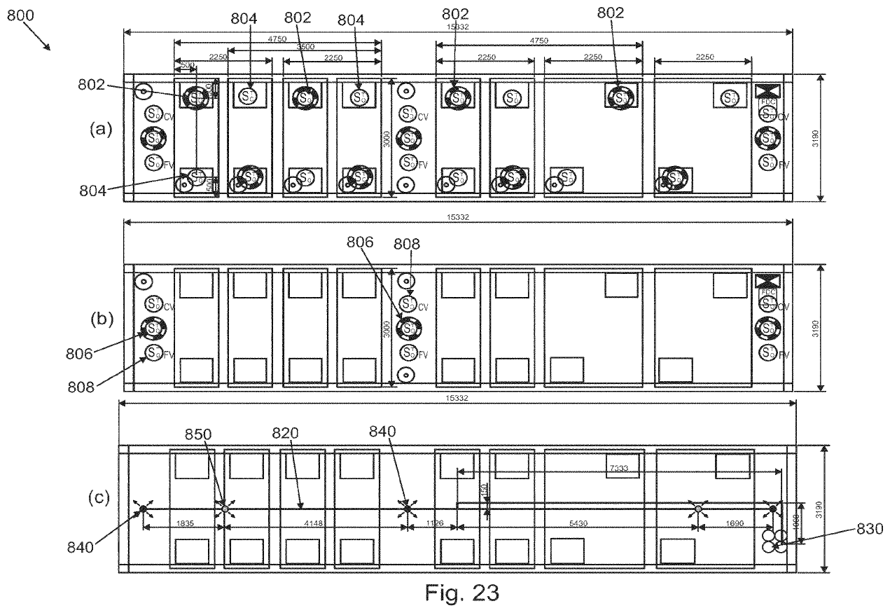

FIG. 23 shows layouts of fire suppression systems 800 according to embodiments of the surveillance, security and/or enforcement unit. The unit may comprise multiple fire suppression systems for extinguishing or preventing fires. The fire suppression systems may include devices to suppress fire in each of the modules and also in the housing of the unit itself, and both of these are shown in FIG. 23a. The fire suppression devices in the housing may suppress fires such as may occur in motors or generators, for example, by such items overheating. FIG. 23b shows the location of fire suppression devices in the housing at locations where modules are not present such as at the ends and middle of the unit. In FIG. 23a fire suppression devices are provided for each module. FIG. 23a shows the unit with eight modules loaded therein. On the left hand side are four modules which may be four 1.5m wide modules. Each module may comprise two fire suppression devices. A first device in each module may be part of a main or primary fire suppression system and the second device may be part of a secondary fire suppression system. The secondary fire suppression system provides redundancy in case the primary system fails. On the right hand side of the module are two 1.5 m wide modules and two 2.5 m wide modules. Again each module includes a fire suppression device for the primary and secondary system. The primary fire suppression devices are indicated by 802 and the secondary devices by 804. The primary and secondary devices are configured in pairs such that there is always a secondary device if the primary device fails. FIG. 23b shows the fire suppression devices for the housing. For example, main ones are indicated by 806 and secondary ones by 808. The main fire suppression system includes fire suppression devices in the modules and housing. The secondary fire suppression system also includes fire suppression devices in the modules and housing. Each fire suppression device may include a sensor for detecting fire, smoke or high temperature. For the modules, the fire suppressant supplied by the fire suppression devices may be a gas or powder because the modules contain many electrical systems. For the unit, the suppressant may also be a gas or powder. When the modules are loaded into the unit, as described earlier, systems in the module are connected by one or more connectors such as Staubli connectors. The main and secondary fire suppression systems may connect to each module through different connectors.

In the modules the fire suppression devices for each module operate independently of those in other modules. This is because a fire in a module will likely be contained in that module and so the devices will only activate in modules in which there is a fire. Conversely, for the fire suppression devices in the unit itself, such as shown in FIG. 23b, if a fire is detected in the unit and outside of the modules, then all of the fire suppression devices will activate to supply fire suppressant, for example, to supply or flood the space in the unit between and outside of the modules to suppress a fire.

For each system a controller may control the fire suppression devices to activate the particular ones required in the vicinity of the fire to suppress the fire. For example, if a small fire is detected in particular module the fire suppression device in that module may be activated. The modules and housing may include sensors to detect the presence of a fire, smoke or a temperature indication indicating a fire is present. Data or signals from the sensors may be fed back to the controller to determine when to activate fire suppression devices. The controller, or another controller, may also determine if the main fire suppression system is working and if not activate the secondary fire suppression system.

Alternatively, instead of a controller connected to the fire suppression devices, the main and secondary fire suppression devices in each module may act independently of others and without a controller. For example, a main fire suppression device in a module or in the housing may be configured to detect a fire, smoke or temperature indicative of a fire and activate accordingly. The secondary fire suppression device may activate if the main one does not, for example, in a predetermined time period of detecting a fire. The secondary fire suppression system provides redundancy.

As mentioned, for the modules the fire suppression devices may connect to the system, and optionally connect to a controller, by a connector when the modules are received into the housing. Each bay in the housing preferably has two or more connectors which connect to the module when the module is loaded into the unit. The main or primary system and devices may connect through a first connector and the secondary system and devices may connect through a second connector. in this way redundancy is provided should a connector fail.

FIG. 23c shows a sprinkler system fitted to the unit. Pipes 820 are shown connected to a supply of water 830 or other fire suppressant. Sprinklers 840 are fitted within the housing at for example, three locations such as the ends and middle of the unit. Sensors may be provided at the same locations as the sprinklers 840. Additional sensors may be provided at other locations 850 such as between the sprinklers 840.

Further embodiments are provided in the following clauses:
A. A surveillance, security and/or enforcement unit comprising a robotic arm, the robotic arm having at least six axes of movement and comprising a base and an end effector, the base being coupled to the unit and the robotic arm arranged to perform a surveillance, security and/or enforcement function, wherein the surveillance, security and/or enforcement unit is configured for deployment from a vehicle or as a vehicle, at a surveillance, security and/or enforcement location.
B. The surveillance, security and/or enforcement unit of clause A, wherein the unit is a trailer or payload arranged for coupling to a vehicle for delivery to a surveillance, security and/or enforcement location, the unit capable of detachment from the vehicle or part of the vehicle.
C. The surveillance, security and/or enforcement unit of clause A or clause B, wherein the unit is trailer or body unit which is detachable from the cab or drive unit of a truck, lorry, van or other vehicle.
D. The surveillance, security and/or enforcement unit of any preceding clause, wherein the end effector is adapted to engage a function module for performing the surveillance, security and/or enforcement function, and the function module comprises at least one of a video camera, stills camera, vehicle speed camera or radar.
E. The surveillance, security and/or enforcement unit of any preceding clause, wherein the function module or surveillance data processing equipment is arranged to perform any one or more of: facial recognition, vehicle number plate recognition, and vehicle speed determination.
F. The surveillance, security and/or enforcement unit of any preceding clause, further comprising a cabin having communication means for transmitting and receiving surveillance data from a function module coupled to the end effector and further comprising surveillance data processing equipment.
G. The surveillance, security and/or enforcement unit of clause F, wherein the data processing equipment includes a controller configured to control the robotic arm to position the end effector at a desired position and orientation to perform surveillance of a selected area or areas.
H. The surveillance, security and/or enforcement unit of clause G, wherein the selected area or areas are selected based on information comprised in the received surveillance data.
I. The surveillance, security and/or enforcement unit of any preceding clause, further comprising communication means for communicating with one or more deployable units and/or a headquarters/command centre to receive surveillance data from said one or more deployable units and/or a headquarters/command centre, and to process said received data.
J. The surveillance, security and/or enforcement unit of clause I, wherein the data processing equipment includes a controller configured to control the robotic arm to position the end effector at a desired position and orientation to perform surveillance of a selected area or areas.
K. The surveillance, security and/or enforcement unit of clause J, wherein the selected area or areas are selected based on information comprised in the received surveillance data.
L. The surveillance, security and/or enforcement unit of any preceding clause, further comprising a launch platform for launching an unmanned aerial surveillance vehicle adapted to communicate with the surveillance, security and/or enforcement unit.
M. A surveillance, security and/or enforcement system comprising:
the surveillance, security and/or enforcement unit of any preceding clause, and further comprising a launch platform for launching an unmanned aerial surveillance vehicle adapted to perform surveillance of areas beyond the vision range of the surveillance, security and/or enforcement unit and communicate with the surveillance, security and/or enforcement unit.
A1. A surveillance, security and/or enforcement management vehicle or vehicle removable trailer or flatbed bed comprising a robotic arm, the robotic arm having at least six axes of movement and comprising at least a base and an end effector, the base being coupled to the vehicle and the 6 robotic arm being arranged to perform a surveillance, security and/or enforcement function.
A2. A surveillance, security and/or enforcement management vehicle or vehicle removable trailer or flatbed of clause A1 wherein the robotic arm is manoeuvrable in order to position the end effector in a plurality of positions such as to move an object from the vehicle to an adjacent surface.
A3. A surveillance, security and/or enforcement management vehicle or vehicle removable trailer or flatbed of any one of clauses A1 and A2 further comprising a guiding track on which the base of the robotic arm is coupled and which is arranged to allow a transverse translational motion of the entire robotic arm relative to the vehicle.
A4. A surveillance, security and/or enforcement management vehicle or vehicle removable trailer or flatbed of any one of clauses A1 to A3 wherein the end effector is a docking plate adapted to receive an interchangeable module.
A5. A surveillance, security and/or enforcement management vehicle or vehicle removable trailer or flatbed of any of clauses A1 to A4 further comprising a control unit to control the motion of the robotic arm, the control unit being configured to process information from at least one data source and control the movement of the robotic arm in response to data received from the at least one data source where connected to the vehicle of any of clauses A1 to A4 or controlled remotely.
A6. A surveillance, security and/or enforcement management vehicle or vehicle removable trailer or flatbed of clause A5, wherein the at least one data source is at least one of a surveillance (CCTV) cameras, facial recognition cameras, number plate recognition cameras, video streaming cameras, a GPS receiver, RFID reader, drone launcher and lander, or applications developed by a third party contractor which has been configured to transmitted or receive data sent from or via the vehicle of any of clauses A1 to A5, CAD software, a map or a plan.
A7. A surveillance, security and/or enforcement management vehicle or vehicle removable trailer or flatbed of any one of clauses A5 and A6, further comprising a security control department located on clause A1.
A8. A surveillance, security and/or enforcement management vehicle or vehicle removable trailer or flatbed of clause A7, located on the flatbed is a control cabin equipped with computers, video monitors, data communication devices and a seating area deemed appropriate to facilitate the functionality of any of clauses A1 to A7.
A9. A surveillance, security and/or enforcement management vehicle or vehicle removable trailer or flatbed of any one of clauses A1 to A8, wherein the end effector is adapted to pick up and release, security and enforcement management equipment.
A10. A surveillance, security and/or enforcement management vehicle or vehicle removable trailer or flatbed of clause A9, wherein the security and enforcement management equipment is at least one of least one of a surveillance (CCTV) cameras, facial recognition cameras, number plate recognition cameras, video streaming cameras or third party security application.
A11. A surveillance, security and/or enforcement management vehicle or vehicle removable trailer or flatbed of any one of clauses A5 to A10, wherein the surveillance, security and enforcement management vehicle bed is arranged to position security vehicle is a position where the vehicle could remain or the removable flatbed dislocated to complete its assigned task.
A12. A surveillance, security and/or enforcement management vehicle or vehicle removable trailer or flatbed of clause A11, maybe connected to an external power supply or network communication cabled for a more secure data transmission.
A13. A surveillance, security and/or enforcement management vehicle or vehicle removable trailer or flatbed of clause A7, wherein the subject area is an area to be surveyed.
A14. A surveillance, security and/or enforcement management vehicle or vehicle removable trailer or flatbed of clause A13, wherein the end effector is adapted to perform a range of security functions.
A15. A surveillance, security and/or enforcement management vehicle or vehicle removable trailer or flatbed substantially as shown in FIGS. 1 to 7.
B1. A surveillance, security and enforcement management vehicle or vehicle removable trailer or flatbed comprising a robotic arm coupled to the vehicle, the robotic arm being movable about at least 5 or six axes, the vehicle further comprising a control unit being configured to process information from at least one data source and controlling the robotic arm in order to automatically survey, launch or receive surveillance equipment.
B2. A surveillance, security and/or enforcement management vehicle or vehicle removable trailer or flatbed of clause B1, surveillance (CCTV) cameras, facial recognition cameras, number plate recognition cameras, video streaming cameras, a GPS receiver, RFID reader, drone launcher and lander, or applications developed by a third party contractor which has been configured to transmitted or receive data sent from or via clauses A1, CAD software, a map or a plan.
B3. A surveillance, security and/or enforcement management vehicle or vehicle removable trailer or flatbed of clause B1 or B2, wherein the robotic arm is configured to stack and/or store applications modules configured for security surveillance purposes within the area of clauses A1.
B4. A surveillance, security and/or enforcement management vehicle or vehicle removable trailer or flatbed vehicle comprising a robotic arm coupled to the vehicle, the robotic arm movable about at least six axes, the vehicle further comprising a control unit being configured to process information from at least one data source and controlling the robotic arm to provide surveillance or security within the aforementioned environment.
B5. A surveillance, security and/or enforcement management vehicle or vehicle removable trailer or flatbed of clause B4, wherein the at least one data source is at least one surveillance (CCTV) cameras, facial recognition cameras, number plate recognition cameras, video streaming cameras, a GPS receiver, RFID reader, drone launcher and lander, or applications developed by a third party contractor which has been configured to transmitted or receive data sent from or via clauses A1, CAD software, a map or a plan.
B6. The vehicle or removable trailer or flatbed of any of clauses A1 to A15 or B1 to B5 further comprising a control cabin equip with computers, video monitors, data communication devices and a seating area deemed appropriate to facilitate the functionality clauses A1, the protective working casing is move via the robotic control unit according to the working envelope of the robotic arm.
B7. The vehicle of any of clauses A1 to A15 or B1 to B56 wherein the work envelope is monitored by a sensor and the robotic arm is stopped if the sensor detects a person or unexpected object within the area
C1. A surveillance, security and/or enforcement management method comprising controlling a robotic 5 or 6 arm coupled to a vehicle to perform a traffic management function, the robotic arm movable about at least six axes.
C2. The surveillance, security and/or enforcement management method of clause C1 wherein the robotic arm is controlled by a control unit, the control unit being provided with data from at least one data source and the control unit control unit controlling the robotic arm in response to the data from the at least one data source.
C3. The surveillance, security and/or enforcement management method of clause C2 wherein the at least one surveillance (CCTV) cameras, facial recognition cameras, number plate recognition cameras, video streaming cameras, a GPS receiver, RFID reader, drone launcher and lander, or applications developed by a third party contractor which has been configured to transmitted or receive data sent from or via clauses A1, CAD software, a map or a plan.
C4. The surveillance, security and/or enforcement management method of clauses 32 or 33 wherein the control unit performs surveillance, security and enforcement management functions on the vehicle or vehicle removable trailer or flatbed so that the robotic arm can be moved to a desired position on a the vehicle to perform the surveillance, security and/or enforcement management function via the modules attached.
C5. The surveillance, security and/or enforcement management method of any one of clauses C2 to C4, wherein the surveillance, security and/or enforcement management functions is the controlling the robotic arm in order to automatically survey, launch or receive surveillance equipment.
C6. The surveillance, security and/or enforcement management method of clause C5, wherein the surveillance, security and/or enforcement management equipment is at least one of a surveillance (CCTV) cameras, facial recognition cameras, number plate recognition cameras, video streaming cameras or third party security application.
C7. The surveillance, security and/or enforcement management method of clauses C5 or C6, wherein surveillance, security and/or enforcement management equipment is positioned on the management vehicle or vehicle removable trailer or flatbed at positions moved manually or remotely as of clauses H.
C8. The surveillance, security and/or enforcement management method of any one of clauses C2 to C4, wherein the surveillance, security and/or enforcement functions via the modules for the relevant environment.
C9. A computer program providing instructions to carry out the method of any one of clauses C3 to C8 either onsite or offsite (Remotely).
D1. A surveillance, security and/or enforcement management vehicle or vehicle removable trailer or flatbed bed cabin adapted to be manned or unmanned as deemed necessary by the command centre and therefore any until could be controlled remotely.
E1. A deployable surveillance, security and/or enforcement unit, comprising:
   a container configured for deployment from a vehicle or by air at a surveillance, security and/or enforcement location; and
   two or more removable modules having equipment for performing surveillance, security and/or enforcement operations,
   wherein the container has a housing with at least one opening for receiving the two or more modules into the container.
E2. The deployable surveillance, security and/or enforcement unit of clause E1, wherein the two or more removable modules comprise any two or more of the following:
   a command module for controlling other modules in the unit and/or sending communications to a remote location;
   a reconnaissance module for performing reconnaissance of the environment surrounding the unit;
   a sampling and diagnostic laboratory module for testing samples for chemical, biological, radiological and/or nuclear species;
   a decontamination module comprising a washroom for decontamination of personnel; and
   a utilities module for providing utilities and/or communications services to other modules in the unit.
E3. The deployable surveillance, security and/or enforcement unit of clause E1 or E2, wherein the container comprises doors such that at least one complete face of the container can be opened to form the at least one opening for receiving the two or more modules.
E4. The deployable surveillance, security and/or enforcement unit of any of clauses E1 to E3, wherein the container is adapted to be deployed at a surveillance, security and/or enforcement location by air from a helicopter.
E5. The deployable surveillance, security and/or enforcement unit of any of clauses E1 to E4, wherein the container is provided in accordance with one of the following:
   configured without wheels for deployment by air;
   configured without wheels for deployment from a land vehicle by crane;
   configured with wheels as a trailer for land based deployment by being towed; or
   configured with wheels and motive drive to be deployed by driving.
E6. The deployable surveillance, security and/or enforcement unit of any of clauses E1 to E5, wherein the container has ruggedized metal faces.
E7. The deployable surveillance, security and/or enforcement unit of any of clauses E1 to E6, wherein the container comprises a plurality of cameras for monitoring the surroundings of the unit.
E8. The deployable surveillance, security and/or enforcement unit of any of clauses E1 to E7, wherein the unit communicates with other units forming a network of units at a surveillance, security and/or enforcement venue.
E9. The deployable surveillance, security and/or enforcement unit of any of clauses E1 to E8, wherein the container is a shipping container.
E10. The deployable surveillance, security and/or enforcement unit of any of clauses E1 to E9, wherein the container has tracks or rails fixed to the floor of the container to guide the loading of modules into the container.
E11. The deployable surveillance, security and/or enforcement unit of any of clauses E1 to E10, one of the two or more modules is a reconnaissance module comprising at least one of:
   a robotic arm configured to move a surveillance, security and/or enforcement device to a position to monitor a target location proximal to the unit; and
   an unmanned aerial vehicle for launching from the reconnaissance module for performing surveillance, security and/or enforcement activities remote from the unit.
E12. The deployable surveillance, security and/or enforcement unit of any of clauses E1 to E11, wherein one of the two or more modules is a reconnaissance module having a robotic arm comprising a base and an end effector, the base coupled to the reconnaissance module, the end effector arranged to receive one of one or more surveillance, security and/or enforcement devices and the robotic arm configured to move the device to a position to monitor a target location.
E13. The deployable surveillance, security and/or enforcement unit of clause E12, further comprising a dock array for receiving and storing the one or more surveillance, security and/or enforcement devices, wherein the robotic arm is configured to manoeuvre the end effector towards the dock array to engage one of the surveillance, security and/or enforcement device.
E14. The deployable surveillance, security and/or enforcement unit of clause E12 or E13, wherein there are two or more surveillance, security and/or enforcement devices and they have different functions, the functions include at least two of:
   a camera configured for collecting images and performing facial recognition of persons in the images;
   a camera configured for collecting images and performing number plate recognition of vehicles in the image;
   a speed sensor for detecting the speed of vehicles passing through a target zone; and
   one more cameras for collecting images 360° around the unit.
E15. The deployable surveillance, security and/or enforcement unit of clause E12 or E13, wherein there are two or more surveillance, security and/or enforcement devices and they have different functions, the functions include one or more of: a UAV servicing application module; a chemical detection module; a biological detection module; and a camera/video surveillance module.
E16. The deployable surveillance, security and/or enforcement unit of any of clauses E12 to E15, wherein one of the surveillance, security and/or enforcement devices has multiple functions and comprises a plurality of sensors for facial recognition, number plate recognition and speed sensing, the plurality of sensors evenly distributed azimuthally around a central axis.
E17. The deployable surveillance, security and/or enforcement unit of clause E15, wherein the one of the surveillance, security and/or enforcement devices further comprises one or more cameras for collecting images covering 360° around the unit.
E18. The deployable surveillance, security and/or enforcement unit of any of clauses E12 to E16, wherein the surveillance, security and/or enforcement devices may comprise:
   one or more sensors for detecting one or more of chemical, biological, radiological or nuclear hazards.
E19. The deployable surveillance, security and/or enforcement unit of any of clauses E12 to E17, wherein the base of the robotic arm is mounted to a lifting platform for raising the robotic arm through an aperture in the roof of the container to enable a surveillance, security and/or enforcement device to monitor the target location.
E20. The deployable surveillance, security and/or enforcement unit of clause E19, wherein the lifting platform comprises a scissor lift.
E21. The deployable surveillance, security and/or enforcement unit of any of clauses E12 to E20, wherein the robotic arm has six-axes of movement.
E22. The deployable surveillance, security and/or enforcement unit of any of clauses E12 to E21, wherein the robotic arm, at full extension, is longer than the width of the container and is arranged to extend to move the surveillance, security and/or enforcement device to a position beyond the width extent of the container.
E23. The deployable surveillance, security and/or enforcement unit of any of clauses E12 to E22, further comprising one or more unmanned aerial vehicles (UAVs) for launching from the reconnaissance module for performing surveillance, security and/or enforcement activities remote from the unit.
E24. The deployable surveillance, security and/or enforcement unit clause E23, wherein the container has an aperture in the roof through which the UAV is launched.
E25. The deployable surveillance, security and/or enforcement unit of clause E23 or E24, wherein the reconnaissance module comprises a landing pad on which the UAV is stationed prior to launch, the UAV is powered by a battery and the UAV is adapted to recharge the battery when on the landing pad.
E26. The deployable surveillance, security and/or enforcement unit of any of clauses E23 to E25, the UAV further comprising a camera or sensors arranged for collecting surveillance, security and/or enforcement data.
E27. The deployable surveillance, security and/or enforcement unit of any of clauses E23 to E26, wherein the UAV comprises a memory and a processor configured to be programmed to control the UAV to fly a predetermined flight route and collect surveillance, security and/or enforcement data.
E28. The deployable surveillance, security and/or enforcement unit of any of clauses E23 to E27, wherein the UAV is configured to be controlled or flown from a command module in the unit or from a control centre at a remote location.
E29. The deployable surveillance, security and/or enforcement unit of any of clauses E23 to E28, wherein the reconnaissance module comprises a plurality of UAVs and the plurality of UAVs are stored in the reconnaissance module in a drawer system, each drawer comprising a landing pad for a UAV, each drawer arranged to slide in and out of a cabinet of the drawer system, the drawers when in a closed position in the cabinet are arranged vertically above each other, and
   the container having an aperture in the roof for launch of the UAVs, the aperture positioned above the position corresponding to that of an open drawer of the drawer system.
E30. The deployable surveillance, security and/or enforcement unit of any of clauses E1 to E29, wherein one of the two or more modules is a sampling and diagnostic laboratory module comprising test equipment for testing for chemical, biological, radiological, and/or nuclear species.
E31. The deployable surveillance, security and/or enforcement unit of clause E30, wherein the container comprises an aperture in the roof, and the sampling and diagnostic laboratory comprises one or more unmanned aerial vehicles (UAVs) for launching through the aperture in the roof of the container, the one or more UAVs comprising apparatus for sampling an environment around the UAV.
E32. The deployable surveillance, security and/or enforcement unit of clause E31, wherein the sampling and diagnostic laboratory further comprises a robot programmed to take the environmental sample from the UAV and submit the sample to a selected one of the test equipment for testing for specified chemical, biological, radiological, and/or nuclear species.
E33. The deployable surveillance, security and/or enforcement unit of any of clauses E30 to E32, wherein the robot is configured to be controlled from a location remote from the container.
E34. The deployable surveillance, security and/or enforcement unit of any of clauses E1 to E33, wherein one of the two or more modules is a washroom for decontamination of personnel from chemical, biological, radiological, and/or nuclear hazards, the washroom comprising a tank for storing water for washing the hazard from the person.
E35. The deployable surveillance, security and/or enforcement unit of any of clauses E1 to E34, wherein one of the two or more modules is a command module for controlling other modules in the unit and comprises communications apparatus for sending or receiving communications from a remote location.
E36. The deployable surveillance, security and/or enforcement unit of clause E35, wherein the communications apparatus is configured for communicating with one or more other deployable surveillance, security and/or enforcement units.
F37. A method of surveillance, security and/or enforcement, comprising:
   deploying a surveillance, security and/or enforcement unit at surveillance, security and/or enforcement location;
   assessing the environment surrounding the surveillance, security and/or enforcement location using automated unmanned modules provided in the unit;
   sending data produced from the step of assessing to a manned remote location; and
   deploying human resources to the surveillance, security and/or enforcement location, including human resources to operate a control module in the unit.
F38. The method of clause F37, wherein the surveillance, security and/or enforcement unit is that of any of the clauses above such as any of clauses E1 to E36.
G39. A surveillance, security and/or enforcement unit comprising a robotic arm, the robotic arm having at least six axes of movement and comprising a base and an end effector, the base being coupled to the unit and the robotic arm arranged to perform a surveillance, security and/or enforcement function, wherein the surveillance, security and/or enforcement unit is configured for deployment from a vehicle or as a vehicle, at a surveillance, security and/or enforcement location.
G40. The surveillance, security and/or enforcement unit of clause G39, wherein the unit is a trailer or payload arranged for coupling to a vehicle for delivery to a surveillance, security and/or enforcement location, the unit capable of detachment from the vehicle or part of the vehicle.
G41. The surveillance, security and/or enforcement unit of clause G39 or G40, wherein the unit is trailer or body unit which is detachable from the cab or drive unit of a truck, lorry, van or other vehicle.
G42. The surveillance, security and/or enforcement unit of any of clauses G39 to G41, wherein the end effector is adapted to engage a function module for performing the surveillance, security and/or enforcement function, and the function module comprises at least one of a video camera, stills camera, vehicle speed camera or radar.
G43. The surveillance, security and/or enforcement unit of any of clauses G39 to G42, wherein the function module or surveillance data processing equipment is arranged to perform any one or more of: facial recognition, vehicle number plate recognition, and vehicle speed determination.

The person skilled in the art will readily appreciate that various modifications and alterations may be made to the above described embodiments without departing from the scope of the appended claims. The embodiments described herein may be combined.

1. A deployable surveillance, security and/or enforcement system, comprising:
a deployable surveillance, security and/or enforcement unit configured for deployment at a surveillance, security and/or enforcement location, the unit comprising two or more removable modules having equipment for performing surveillance, security and/or enforcement operations and the unit having a housing with at least one opening for receiving the two or more modules into the unit; and
one or more bogies, each bogie comprising a chassis, wheelset and a pair of continuous tracks, each of the continuous tracks formed of linked track plates and the continuous tracks driven by one or more wheels of the wheelset, the bogie detachably coupled to the deployable surveillance, security and/or enforcement unit.

2. The system of claim 1, wherein the bogie comprises a rotatable coupling for coupling to the unit, the rotatable coupling comprising an inner ring and outer ring, the inner ring configured to rotate inside the outer ring, wherein the inner ring is coupled to the bogie and the outer ring is detachably coupled to the unit, and the tracks, chassis and wheelset are configured to rotate with respect to the unit by the rotatable coupling.

3. The system of claim 2, wherein the bogie further comprises a pair of electric motors and each of first and second tracks of the pair of tracks are configured to be driven by a respective electric motor.

4. The system of claim 3, wherein:
the bogie comprises batteries for powering the electric motors, and or
the unit comprises a source of electrical power, such as a generator, and the electric motors are configured to receive electrical power from the source of electrical power via detachable connectors.

5. The system of claim 4, wherein the unit comprises a source of electrical power, such as a generator, and the electric motors are configured to receive electrical power from the source of electrical power via the detachable connectors, and
wherein the detachable connectors are also configured for receiving communications from the unit, wherein the detachable connectors comprise a bogie connector and unit connector which connect together, the bogie connector is located inside the inner perimeter of the inner ring.

6. The system of any preceding claim, comprising two bogies, a first of the two bogies is detachably coupled towards a first end of the unit and a second of the two bogies is detachably connected towards a second end of the unit, such that the unit is supported by, and movable by the two bogies.

7. A deployable surveillance, security and/or enforcement unit configured for deployment at surveillance, security and/or enforcement location, the unit comprising:
two or more removable modules having equipment for performing surveillance, security and/or enforcement operations,
wherein the unit has a housing with one or more openings for receiving the two or more modules into the unit, and
the unit comprises lifting jacks configured to lift the unit above ground level.

8. The unit of claim 7, wherein each of the lifting jacks is a screw jack comprising a leg extendable from the unit and driven by a motor.

9. The unit of any of claim 7 or claim 8, wherein the lifting jacks are respectively mounted at corners of the unit.

10. The unit of claim 9, wherein the unit comprises pillars at the corners of the unit and one or more doors for opening or closing the one or more openings, the pillars configured to pivotably support the doors, wherein each pillar is further configured with one of the lifting jacks such that a leg of the lifting jacks is configured to extend from and retract into the base of the pillar.

11. The unit of any of claims 7 to 10, further comprising a controller configured to set the extension or retraction of the lifting jacks and the controller is configured to drive the lifting jacks independently or collectively.

12. The unit of any of claims 7 to 11, wherein each lifting jack is configured with a position encoder and the position encoder is configured to: provide to a controller an indication of the amount of extension or retraction of the lifting jack from the unit; and/or to receive from a controller an indication of the amount of extension, retraction or movement of the lifting jack required.

13. The unit of claim 12, wherein each lifting jack is further configured with a laser measurement device for measuring a distance from the unit, such as the base of the unit, to the ground.

14. The unit of claim 12 or claim 13, wherein the unit further comprises a gyroscope configured to provide an indication to a controller of the inclination of the unit, and the controller is configured to drive the lifting jacks to level the unit.

15. The unit of any of claims 7 to 14, wherein the unit is a square or rectangular shape with first sides longer than second sides, and lifting jacks are provided at each of the four corners of the unit.

16. The unit of claim 15, further comprising two further lifting jacks provided at mid-points along the long sides of the unit.

17. A deployable surveillance, security and/or enforcement unit configured for deployment at surveillance, security and/or enforcement location, the unit comprising:
two or more removable modules having equipment for performing surveillance, security and/or enforcement operations,
wherein the unit has a housing with one or more openings for receiving the two or more modules into the unit, and
the unit comprising an air-conditioning system configured to receive air external to the unit and supply heated or cooled air to the two or more removable modules, wherein the air-conditioning system is configured such that:
the received external air cools or heats a heat exchanger system for cooling or heating air recirculated to the two or more removable modules, and/or
the received external air is filtered and cooled or heated and supplied to the two or more removable modules.

18. The unit of claim 17, wherein the unit comprises two air-conditioning systems of which a first air-conditioning system is configured in the unit to receive external air from a first side of the unit and the second air-conditioning system is configured to receive external air from a second side of the unit opposite to the first side.

19. The unit of claim 18, wherein the unit comprises four air-conditioning systems of which first and third air-conditioning systems are configured in the unit to receive external air from a first side of the unit and second and fourth air-conditioning systems are configured to receive external air from a second side of the unit opposite to the first side.

20. The unit of claim 19, further comprising a controller configured to control the four air-conditioning systems such that if the first or second air-conditioning system fails, the third or fourth air-conditioning system is brought into operation to supply air-conditioned air to the two or more removable modules.

21. The unit of claim 19 or claim 20, further comprising a controller configured to control the four air-conditioning systems such that if the first and third air-conditioning systems configured to receive external air from the first side of the unit are blocked or unable to receive external air, the second or fourth air-conditioning system is brought into operation to supply air-conditioned air to the two or more removable modules.

22. The unit of any of claims 17 to 21, wherein the unit comprises air intake ports in the roof or at the top of the walls of the housing of the unit to take-in or receive external air for the air-conditioning systems and each system has a separate intake port.

23. A deployable surveillance, security and/or enforcement unit configured for deployment at surveillance, security and/or enforcement location, the unit comprising:
two or more removable modules having equipment for performing surveillance, security and/or enforcement operations,
wherein the unit has a housing with one or more openings for receiving the two or more modules into the unit, and
the unit comprises a retractable satellite antenna at the top of the housing.

24. The unit of claim 23, wherein the housing comprises pillars at the corners of the unit and the satellite antenna is configured to fold-up and retract into one of the pillars.

25. A deployable surveillance, security and/or enforcement unit configured for deployment at surveillance, security and/or enforcement location, the unit comprising:
two or more removable modules having equipment for performing surveillance, security and/or enforcement operations,
wherein the unit has a housing with one or more openings for receiving the two or more modules into the unit, and
the unit comprises a door system comprising first and second doors that are configured together to move to open and close a first opening of the plurality of openings, the first door is mounted to the housing for pivoting movement to open and close a first portion of the first opening and the second door is mounted to the first door to translate linearly with respect to the first door between retracted and extended positions for opening or closing a second portion of the first opening.

26. The unit of claim 25, wherein the second door is mounted to slide on one or more tracks for retraction and extension.

27. The unit of claim 25 or claim 26, wherein the second door is mounted to retract into, and extend from, a cavity in the first door to respectively open and close the second portion of the first opening.

28. The unit of claim 27, wherein the second door is mounted on a track extending into the cavity of the first door.

29. The unit of claim 28, wherein with the first door in the closed position the track extending into the cavity of the first door aligns with a track in the base of the housing at the second portion of the first opening such that, with first door in the closed position, the second door is configured to translate from the cavity in the first door along the track in the base of the housing to close the second portion of the first opening.

30. The unit of any of claims 27 to 29, wherein the second door has a height less than the first door to fit inside the cavity of the first door.

31. The unit of any of claims 27 to 30, wherein the second door, when in the retracted position, does not extend beyond the cavity of the first door.

32. The unit of any of claims 25 to 31, wherein the housing comprises a pillar and the first door is arranged to pivot at the pillar.

33. The unit of any of claims 25 to 32, wherein the pillar is at a corner of the unit.

34. The unit of claim 32 or claim 33, wherein the pillar comprises a motor arranged to drive pivoting rotation of the first door to move the first door between open and closed positions.

35. The unit of any of claims 25 to 34, wherein the housing comprises a second pillar and the second door, in the extended position, extends into a groove in the second pillar.

36. The unit of any of claims 25 to 35, wherein the unit has a rectangular shape with first sides longer than second sides, the door system opens and closes the first opening which is in a first side, the unit further comprising a second door system arranged to open and close a second opening in the first side.

37. A deployable surveillance, security and/or enforcement unit configured for deployment at surveillance, security and/or enforcement location, the unit comprising:
two or more removable modules having equipment for performing surveillance, security and/or enforcement operations,
wherein the unit has a housing with one or more openings for receiving the two or more modules into the unit, and
the unit comprises a fire suppression system configured to suppress fires in the two or more removable modules and in the housing of the unit.

38. The unit of claim 37, wherein the unit comprises bays for receiving the removable modules and each bay is sized to receive a module, the fire suppression system comprising one or more connectors in each bay for connecting to the module in the bay and each module comprising a fire suppression device.

39. The unit of claim 37 or claim 38, wherein the housing comprises a plurality of fire suppression devices connected to the fire suppression system.

40. The unit of any of claims 37 to 39, wherein the fire suppression system is a first fire suppression system and the unit further comprising a second fire suppression system to suppress fires in the two or more removable modules and in the housing of the unit.

41. The unit of claim 38 or 39, wherein the connectors are first connectors and the fire suppression devices are first fire suppression devices, and
the unit comprises a second fire suppression system, the second fire suppression system comprising a second connector in each bay for connecting to each module in the unit and each module comprising a second fire suppression device, the housing comprising a plurality of second fire suppression devices connected to the second fire suppression system, and
the unit further comprising a controller configured to control the first and second fire suppression systems such that if the first fire suppression system fails the second fire suppression system is activated.

42. The unit of any of claims 38 to 41, wherein the connectors are configured to connect the fire suppression system to the modules when the modules are received in the housing.
